(19) United States
(12) Patent Application Publication
(10) Pub. No.: US 2025/0371413 A1
(43) Pub. Date: Dec. 4, 2025

(54) Tied Preference Optimization for Sequence Processing Models

(71) Applicant: DeepMind Technologies Limited, London (GB)

(72) Inventors: Gil Shamir, Sewickley, PA (US); Bilal Piot, London (GB)

(21) Appl. No.: 18/732,174

(22) Filed: Jun. 3, 2024

(51) Int. Cl. G06N 20/00; G06N 7/01

(52) U.S. Cl. CPC G06N 20/00; G06N 7/01

(57) ABSTRACT

Provided are systems and methods for fine-tuning sequence processing models to human preferences. The approaches can account for tied preferences between pairs of sequences and, therefore, can be referred to as Tied Preference Optimization (TPO). Example sequence processing models include so-called large language models (LLMs), large multimodal models (LMMs), and other models that are configured to process inputs and/or generate outputs that are structured as a series of data elements such as tokens.

### FIELD

The present disclosure relates generally to machine learning processes and machine-learned devices and systems. More particularly, the present disclosure relates to a generalized approach to direct preference optimization of sequence processing models with ties.

### BACKGROUND

A computing system can receive input(s). The computing system can execute instructions to process the input(s) to generate output(s) using a parameterized model. For example, the input can be a query or a prompt and the output can be a response to the query or the prompt. The computing system can obtain feedback on its performance in generating the outputs with the model. For example, the computing system can generate feedback by evaluating its own performance and/or the computing system can receive feedback from an external source. The computing system can update parameters of the model based on the feedback to improve its performance. In this manner, the computing system can iteratively “learn” to generate the desired outputs. The resulting model is often referred to as a machine-learned model.

Neural networks are a specific type of machine learning model that employ one or more layers of nonlinear units to predict an output for a received input. Some neural networks include one or more hidden layers in addition to an output layer. The output of each hidden layer is used as input to the next layer in the network, e.g., the next hidden layer or the output layer. Each layer of the network generates an output from a received input in accordance with current values of a respective set of parameters.

### SUMMARY

Aspects and advantages of embodiments of the present disclosure will be set forth in part in the following description, or can be learned from the description, or can be learned through practice of the embodiments.

One example aspect of the present disclosure is directed to a method for generating a preference optimization loss function. The method includes selecting a reward function, a regularizer, and a pairwise loss function. The method includes optimizing a single-sequence generation objective which maximizes the selected reward function with regularization according to the selected regularizer, wherein said optimizing results in a solution expression for the selected reward function, wherein the solution expression is a function of a target probability associated with a target sequence processing model and a reference probability associated with a reference sequence processing model. The method includes expressing a pairwise reward difference between the solution expression applied to a first sequence of tokens and the solution expression applied to a second sequence of tokens. The method includes generating the preference optimization loss function by applying the selected pairwise loss function to fit the pairwise reward difference to a human preference label, wherein the human pairwise preference label comprises a single label that describes a preference between the first sequence of tokens and the second sequence of tokens.

Some example implementations can include some or all of the following features. In some implementations, optimizing the single-sequence generation objective comprises distributing respective probabilities for a first tied preference event and a second tied preference event to label values for a first non-tied preference event and a second non-tied preference event. In some implementations, the selected reward function comprises a per-sequence expected probability of a positive preference. In some implementations, the selected reward function comprises a logit score or a log of a preference probability. In some implementations, the selected pairwise loss function comprises a median loss function. In some implementations, the selected reward function comprises a logit score, wherein the selected pairwise loss function comprises a square loss function, and wherein the human pairwise preference label comprises a fractional preference label. In some implementations, the regularizer comprises a distance measure applied between a target distribution of the target sequence processing model and a reference distribution of the reference sequence processing model. In some implementations, the selected regularizer comprises a reverse KL divergence between the reference distribution and the target distribution. In some implementations, the selected reward function comprises a preference probability score and the selected pairwise loss function comprises a cross entropy loss. In some implementations, the selected reward function comprises a probability reward function, and wherein the selected regularizer comprises: a combination of a KL divergence and a reverse KL divergence; a Jensen-Shannon divergence; or an Lp regularizer, excluding L zero and L infinity. In some implementations, the selected pairwise loss function comprises: a cross entropy loss, a square loss, a median loss, or a hinge loss.

Another example aspect is directed to a computing system for preference optimization of sequence processing models, the computing system comprising one or more processors and one or more non-transitory computer-readable media that collectively store instructions that, when executed by the one or more processors, cause the computing system to perform operations. The operations include obtaining, by the computing system, a pairwise preference training example comprising a first sequence of tokens, a second sequence of tokens, and a pairwise preference label, wherein the pairwise preference label comprises one or more label values corresponding to a first non-tied preference event in which the first sequence of tokens is preferred over the second sequence of tokens or a second non-tied preference event in which the second sequence of tokens is preferred over the first sequence of tokens. The operations include evaluating, by the computing system, a tied preference optimization loss function that comprises a pairwise preference probability expression that represents a predicted likelihood of the first non-tied preference event, wherein the pairwise preference probability expression results from distributing respective probabilities for a first tied preference event and a second tied preference event to the label values for the first non-tied preference event and the second non-tied preference event, wherein the first tied preference event comprises neither the first sequence of tokens nor the second sequence of tokens being preferred and the second tied preference event comprises both the first sequence of tokens and the second sequence of tokens being preferred. The operations include modifying, by the computing system, one or more values of one or more parameters of a target sequence processing model based on the tied preference optimization loss function.

Some example implementations can include some or all of the following features. In some implementations, the pairwise preference probability expression represents the predicted likelihood of the first non-tied preference event based on first and second target probabilities respectively generated by the target sequence processing model for the first and second sequences of tokens and first and second reference probabilities respectively generated by a reference sequence processing model for the first and second sequences of tokens. In some implementations, the tied preference optimization loss function comprises a negative expectation of a first logarithm of a first expression, the first expression comprising one plus a hyperparameter times a second logarithm of a first ratio of the first target probability to the first reference probability minus the hyperparameter times a third logarithm of a second ratio of the second target probability to the second reference probability. In some implementations, evaluating the tied preference optimization loss function comprises clipping the first expression within the first logarithm to enforce constraints on a difference between first and second positive preference probabilities for the first and second sequences of tokens. In some implementations, the tied preference optimization loss function comprises an expectation of an absolute value of a first expression, the first expression comprising a hyperparameter times a first logarithm of a first ratio of the first target probability to the first reference probability minus the hyperparameter times a second logarithm of a second ratio of the second target probability to the second reference probability minus one. In some implementations, the tied preference optimization loss function comprises an expectation of an absolute value of a first expression, the first expression comprising the minimum between zero or a second expression, the second expression comprising a hyperparameter times a first logarithm of a first ratio of the first target probability to the first reference probability minus the hyperparameter times a second logarithm of a second ratio of the second target probability to the second reference probability minus one.

Another example aspect is directed to one or more non-transitory computer-readable media that collectively store a target sequence processing model that has been trained using a preference optimization loss function, the preference optimization loss function having been generated through performance of operations. The operations include obtaining a general objective comprising a reward function of a learned per-sequence expected probability of a positive preference and a distance measure applied between a target distribution of the target sequence processing model and a reference distribution of a reference sequence processing model. The operations include solving the general objective for a solution expression of the target distribution of the target sequence processing model for a particular output sequence of tokens. The operations include expressing, in terms of the solution expression, a difference between the reward function applied to a first sequence of tokens and the reward function applied to a second sequence of tokens. The operations include applying a pairwise loss to match the difference to a pairwise preference label associated with the first sequence of tokens and the second sequence of tokens.

Some example implementations can include some or all of the following features. In some implementations, the reward function comprises a preference probability score and the pairwise loss comprises a cross entropy loss. In some implementations, the distance measure comprises a reverse KL divergence between the reference distribution and the target distribution. In some implementations, the distance measure comprises a combination of a KL divergence and a reverse KL divergence. In some implementations, the distance measure comprises a Jensen-Shannon divergence. In some implementations, the distance measure comprises an Lp regularizer, excluding L zero and L infinity. In some implementations, the pairwise loss comprises: a cross entropy loss, a square loss, or a hinge loss. In some implementations, the preference optimization loss function evaluates first and second target probabilities respectively generated by the target sequence processing model for the first and second sequences of tokens and first and second reference probabilities respectively generated by the reference sequence processing model for the first and second sequences of tokens. In some implementations, the preference optimization loss function comprises a negative expectation of a logarithm of a sigmoid of a first expression, the first expression comprising a hyperparameter times a first ratio of the second reference probability to the second target probability minus the hyperparameter times a second ratio of the first reference probability to the first target probability, and wherein the expectation is conditioned on the first sequence being preferred over the second sequence. In some implementations, the preference optimization loss function comprises an expectation of a square of a first expression, the first expression comprising a hyperparameter times a first ratio of the second reference probability to the second target probability minus the hyperparameter times a second ratio of the first reference probability to the first target probability minus one. In some implementations, the preference optimization loss function comprises an expectation of a square of a first expression, the first expression comprising a hyperparameter divided by two times a first logarithm of one plus a first ratio of the second reference probability to the second target probability minus the hyperparameter divided by two times a second logarithm of one plus a second ratio of the first reference probability to the first target probability minus one. In some implementations, the preference optimization loss function comprises an expectation of a square of a first expression, the first expression comprising a hyperparameter times the first target probability minus the first reference probability minus the second target probability plus the second reference probability minus one-half or a fractional preference label.

Other aspects of the present disclosure are directed to various systems, apparatuses, non-transitory computer-readable media, user interfaces, and electronic devices. For example, a non-transitory computer-readable media can store a model that has been trained using any of the preference optimization loss functions described herein.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 is a block diagram of an example approach for training sequence processing models according to example implementations of aspects of the present disclosure;

FIGS. 2A-B, 3A-B, and 4A-D a graph diagrams demonstrating preference optimization behaviors according to example implementations of aspects of the present disclosure;

FIG. 5 is a flow chart diagram illustrating an example method for training a machine-learned model according to example implementations of aspects of the present disclosure;

FIG. 6 is a flow chart diagram illustrating an example method for generating a loss function according to example implementations of aspects of the present disclosure;

FIG. 7 is a flow chart diagram illustrating an example method for deriving a loss function according to example implementations of aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

### Overview

Example aspects of the present disclosure are directed to systems and methods for fine-tuning sequence processing models to human preferences. Example implementations of the proposed approaches can account for tied preferences between pairs of sequences or sequence generation modeling methods for which ties are a natural occurrence with a nonzero probability. Therefore, some example implementations can be referred to as Tied Preference Optimization (TPO). Example sequence processing models include so-called large language models (LLMs), large multimodal models (LMMs), and other models that are configured to process inputs and/or generate outputs that are structured as a series of data elements such as tokens.

According to one aspect, the proposed TPO approaches can define a target optimized on both the reference and human preference distributions. Further, unlike certain prior approaches, the proposed TPO techniques can align a pairwise fine-tuning training objective with a per-sequence pointwise generation method where a binary reward label model is assumed. To achieve this alignment, the proposed approaches can apply a pairwise ranking loss with tied labels that allows training on all sequences by distributing (e.g., uniformly distributing) the cases where the labels are tied between a positive and negative training label. As a result, the preference model is more subtle. Overfitting to a preferred sequence can also be reduced.

The proposed approaches can also be used to generalize fine-tuning objectives where specific choices of losses can lead to new and other techniques. Specifically, the present disclosure also presents a more general framework which allows various designs of fine-tuning objectives and regularization, which can be then combined with pairwise methods that avoid misalignment between a pointwise sequence generation method and pairwise losses with binary reward label models. The different regularization methods can focus fine-tuning on different design criteria, leading each to a different offline fine-tuning objective.

More particularly, the present disclosure introduces approaches for fine-tuning large language models according to human preferences. For instance, in some implementations, the TPO method can be employed to fine-tune a language model for applications such as content recommendation systems, personalized virtual assistants, text generation tools, or domain-specific applications where responses that align with certain preferences (e.g., domain-specific preferences) are beneficial.

Example implementations of TPO utilize a pairwise ranking loss with binary reward or preference labels which accounts for tied labels, which allows for the inclusion of all sequences in training. Specifically, in some situations human raters may in fact have a tied preference between two generated text sequences (e.g., the rater feels that the sequences are equally preferred or equally unpreferred). However, this tied preference is often not reflected in the labels contained in the training data, which may be limited to capturing non-tied situations. The proposed techniques provide a more nuanced model loss framework that better aligns the loss applied to the model with the reality that raters may exhibit ties in preference, even when such ties are not reflected in the preference labels contained in the training data.

The concept of ties is relevant in any situation in which one views human preference labels as binary (stochastic) labels that indicate preference of one sequence over another. Aligning such a pairwise model with a stochastic single sequence (trajectory) generation model implies a nonzero probability that two sequences receive equal (tied) labels. Such a relation will exist even if human raters always choose to prefer one sequence over another because the generation model will only generate a single sequence at a time (with a single reward probability).

In addition, the proposed techniques can reduce the likelihood of overfitting to highly preferred sequences, which might otherwise dominate the result of the training process. For example, the preference model can be fine-tuned to balance between reference model outputs and human preference scores, potentially leading to a more diverse range of generated content.

In some implementations, the TPO framework can be adapted to include various fine-tuning objectives and regularization methods. These can be tailored to different design criteria, which may be beneficial for specific applications such as language model training for niche domains or for generating content with particular stylistic requirements.

The present disclosure also illustrates how different loss functions can be applied within the TPO framework. This flexibility allows for a wide range of possible applications, such as adjusting the model's sensitivity to certain types of content or fine-tuning the model to prioritize certain linguistic structures.

Furthermore, TPO can be extended to include a more general regularization term. This term can be varied to focus fine-tuning on different aspects of the model's output, such as accuracy, fluency, or adherence to specific content guidelines. For example, in some implementations, a regularization term could be designed to ensure that the fine-tuned model remains close in some sense to a pre-trained reference model, thereby maintaining general language understanding while optimizing for preferences, but focusing on maintaining some aspects of closeness to the reference model while allowing the fine-tuned model to diverge away from the reference on others.

More generally, example aspects of the present disclosure are directed to a more general framework for generating preference optimization loss functions for sequence processing models. The general framework accommodates various choices of reward functions, regularizers, and pairwise loss functions. The framework addresses the alignment between a model's generation of sequences and the human preferences indicated by pairwise labels.

In particular, one approach for generating a preference optimization loss function within the general framework includes selecting a reward function, a regularizer, and a pairwise loss function. In some implementations, the reward function can encompass various formulations such as a per-sequence expected probability of a positive preference, a logit score, or a log of preference probability. These choices allow for flexibility in defining how the reward for each sequence is calculated based on the underlying probabilities modeled by the sequence processing frameworks.

The regularizer can define a distance measure between a target distribution of a target sequence processing model and a reference distribution of a reference sequence processing model. Various forms of regularizers can be employed, including but not limited to reverse KL divergence, a combination of KL divergence and reverse KL divergence, Jensen-Shannon divergence, or an Lp regularizer. These regularizers help in maintaining a balance between the target and reference models, ensuring that the fine-tuned model does not diverge significantly from the expected distribution while still aligning closely with human preferences.

The pairwise loss function can fit the pairwise reward difference to the human pairwise preference label. The loss function could be a cross-entropy loss, square loss, median loss, or hinge loss, among others. This selected pairwise loss function can define how the differences in rewards between pairs of sequences are penalized during the optimization process, influencing the model's sensitivity to the discrepancies between predicted preferences and actual human labels.

Once the reward function, regularizer, and loss function have been selected, a single-sequence generation objective can be optimized to obtain a solution expression for the selected reward function. For example, the single-sequence generation objective can maximize the selected reward function with regularization according to the selected regularizer. The solution expression can express the reward as a function of a target probability associated with a target sequence processing model and a reference probability associated with a reference sequence processing model.

A pairwise reward difference can then be defined that evaluates the difference between the solution expression applied to a first sequence of tokens and the solution expression applied to a second sequence of tokens. Finally, a preference optimization loss function can be generated by applying the selected pairwise loss function to fit the pairwise reward difference to a human preference label. Specifically, the human pairwise preference label can be a single label that describes a preference between the first sequence of tokens and the second sequence of tokens.

The systems and methods of the present disclosure provide a number of technical effects and benefits. As one example, the proposed techniques reduce the potential for overfitting of the reward model and the possible mismatch between pairwise labels and modeling. Reducing overfitting of preferred sequences is a benefit because it enhances the model's ability to diversify its responses to prompts without highly preferring a single response. This leads to more reliable and technically efficient performance of machine learning systems across diverse scenarios.

As another example technical effect, the TPO techniques can flexibly accommodate various scenarios where different regularization versions may be beneficial. For example, in some implementations, the method can be adapted to prioritize certain aspects of language generation, such as creativity or adherence to formal language, depending on the desired application. This adaptability in fine-tuning not only improves the technical efficacy of the resulting models in their respective domains but also maximizes the utility and efficiency of the computational resources dedicated to model training.

Thus, the proposed TPO techniques enhance the computational efficiency and reliability of sequence processing models such as LLMs. By introducing a pairwise ranking loss with tied labels, the technology enables the training of LLMs on all sequences, including those where human raters do not distinctly prefer one sequence over another. This approach ensures that the fine-tuning process is more representative of real-world scenarios where clear-cut preferences may not be available, leading to a more robust and technically sound model. It also matches deployed fine-tuned models with a binary preference model, so that single sequence generation is aligned with the fine-tuned model.

### Introduction

In Reinforcement Learning with Human Feedback (RLHF) (See, e.g., Ziegler et al. “Fine-Tuning Language Models from Human Preferences” ArXiv:1909.08593 (2020) and Ouyang, Long et al. “Training language models to follow instructions with human feedback.” ArXiv:2203.02155 (2022)), a pre-trained reference Large Language Model (LLM) is fine-tuned by human preference labels to specific tasks defined by these preferences. In the classical setting, the LLM generates a pair of sequences in response to a prompt, and a pairwise ranking model is trained as a reward model learning the human preferences. Then, the LLM is tuned iteratively, by generating new sequences in response to prompts on which the reward is predicted, and then the reward is maximized constrained by a regularization term that ensures the model does not diverge too much from the reference LLM.

Direct Preference Optimization (DPO) (Rafailov, Rafael et al. “Direct Preference Optimization: Your Language Model is Secretly a Reward Model.” ArXiv abs/2305.18290 (2023)) fast-tracks this idea by describing the optimization target sequence distribution in terms of the reference predictions and the reward scores. The relation between reference, reward and target is then used to express the reward score in terms of the reference and target distributions. That score, in turn, is applied to a pairwise ranking loss used originally for training the reward model. With this substitution, instead of directly training a reward model, implicit training of the pairwise reward scores trains to optimize the target distribution.

Both RLHF and DPO give an exponential weight to the preference model over the reference. While, on one hand, the purpose of the reference model is mainly to initialize the process; on the other hand, such upweighting of the preference may result in overfitting the model to sequences with large preference, suppressing competitor sequences that may be reasonable to generate and explore for further optimization.

Applying a more subtle balance between the reference and the preference scores can lead to better exploration and reduce such overfitting. A general framework was recently proposed which gives more control to balancing between a function of the preference prediction and the reference model. Specifically, Identity Preference Optimization (IPO) (Azar, Mohammad Gheshlaghi et al. “A General Theoretical Paradigm to Understand Learning from Human Preferences.” ArXiv abs/2310.12036 (2023)) applies an identity function on the preference prediction. This gives a more subtle relation between the preference and the reference model, which can reduce such overfitting by essentially bounding the rate in which the preference increases in the total reward. A function of the preference is weighted against a regularization KL divergence term between the target and the reference distribution, which is aimed at keeping the target distribution close to the reference one. Additional annealing of a hyperparameter that governs the tradeoff between reference and preference allows for a gradual graceful shift from emphasizing the reference with little fine-tuning data, but slowly shifting the emphasis towards the preference model.

Both RLHF and DPO have been described with training a pairwise ranking loss between a preferred and a non-preferred sequence, relying on human labels that always make a choice between the two sequences. However, they both are then followed by pointwise (single trajectory) sequence generations that generate a single sequence at a time. Detrimentally, these fine-tuning and generation assumptions are misaligned by assuming that the same ranking scores produced by the pairwise loss for a single binary preference can be applied as individual pointwise single-trajectory preference scores that can be used as logits of the probability that an individual sequence is preferred. Such a model that assumes a binary probability of each sequence being preferred is only true if the pairwise ranking model trains only on events in which one sequence is in fact preferred over the other, giving the conditional probability of such a preference conditioned on the event that there are no preference ties between the sequences. However, forcing labels to always prefer one sequence over the other is not true to this model, as demonstrated below.

Consider, for example, a situation where 50% of ratings prefer sequence A over B and the other 50% of ratings prefer B over A. This is possible for a model that models the preference between A and B as a single random variable. However, a model that uses separate binary logit preference scores to generate each of A and B individually and independently of one another implicitly predicts a respective “thumbs-up/thumbs-down” random variable for each of these sequences. For a generation model in the latter setting, all four combinations of preference pairs are possible, including the two pair outcomes that allow ties between the drawn preferences of the two sequences. Mapping the 50/50 case into such a model gives no valid solution to the probabilities of positive preferences of both A and B, because this case excludes the remaining two possible outcomes.

In some labeling applications, multiple raters are asked to give preference labels to a single pair of sequences, and a fractional preference score is generated, giving the fraction of times each of the two is preferred. For example, if sequence y_{w} is preferred 70% of the time over sequence yₗ, we can hypothesize that a 0.4 fraction of the examples had the event y_{w}>yₗ, in which the sequence y_{w} was preferred over yₗ. Applying this methodology in fine-tuning does comply with the approach that trains only on events in which one sequence is preferred over the other. However, such a model would push the preference model to estimate larger logit preference score differences between the sequences that may overestimate the real differences. It is, in fact, possible in the described example that we have observed 70% of pairs where y_{w} was preferred over yₗ and 30% pairs in which the opposite preference was observed. It is also possible, however, that in 60% of pairs we observed a tie in preference, while in 40% we observed that y_{w} was preferred over yₗ. Assigning a 0.7 weight for y_{w} and 0.3 for yₗ is true to the first case, while assigning a 0.4 weight only for y_{w} being preferred is true for the second. If we apply the 0.4 weight for the first case, we will overestimate the differences.

If one assumes that sequences and their preferences are generated by a pointwise model, it implies that generations of a pair of sequences are independent. Thus, there are nonzero probabilities to the event that both sequences are preferred by a human and the event that both sequences are not preferred by the human.

To address both the overfitting of the reward and a possible mismatch between pairwise labels and modeling, the present disclosure provides training approaches (e.g., fine-tuning approaches) which can be referred to as Tied Preference Optimization (TPO). Some example implementations of TPO define a target optimized on both the reference and preference (or target) distributions. The preference model used in some example implementations of TPO is more subtle to reduce overfitting to a preferred sequence. In addition, some example implementations of TPO apply a pairwise ranking loss with tied labels that allows training on all sequences by distributing (e.g., uniformly distributing) the cases where the labels are tied between existing non-tied training labels (e.g., a positive and a negative training label). Various different losses can be applied within the proposed TPO approach.

Further aspects of the present disclosure are directed to a more general framework for generation of preference optimization losses. For example, the framework includes a more general regularization term, where different scenarios can motivate using one regularization version over the other. The present disclosure provides TPO-like objectives for multiple different settings within the framework. Further, in order to achieve alignment between pointwise generation and pairwise fine-tuning when one assumes a binary pairwise preference model, pairwise fine-tuning need only be applied on pairs in which one sequence is truly preferred over the other.

### Example Alignment Setting

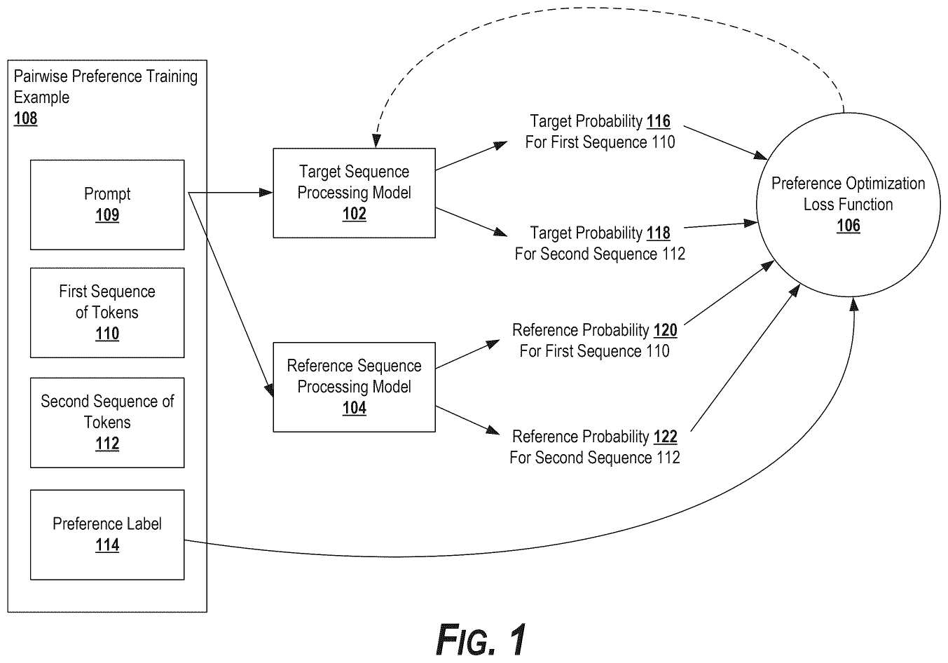

FIG. 1 illustrates a graphical diagram of an example alignment setting. In particular, FIG. 1 illustrates a target sequence processing model 102, a reference sequence processing model 104, and a preference optimization loss function 106. The target sequence processing model 102 can be trained using the preference optimization loss function 106 (e.g., as shown by the dashed line).

In some implementations, the reference sequence processing model 104 can be a pre-trained sequence processing model that has been trained on a large corpus of data. In some implementations, the reference sequence processing model 104 may have been further anchored to a representative dataset by an additional Supervised Fine-Tuning (SFT) stage.

In some implementations, at the start of the illustrated training process, the target sequence processing model 102 can be initialized from the reference sequence processing model 104. In other implementations, the target sequence processing model 102 may be a different model from the reference sequence processing model 104. For example, the target sequence processing model 102 may be a smaller model than the reference sequence processing model 104 (e.g., in terms of parameter count or other metric of model size).

In general, each of the target sequence processing model 102 and the reference sequence processing model 104 can respectively operate to process some input prompt x to sample or generate a sequence y of tokens of some maximum length T as an output, where each token in the output sequence takes values vϵV in a vocabulary of |V|=M tokens. For example, the reference sequence processing model 104 defines a probability function (based on some policy) π_{ref}(y|x) giving a conditional probability of the sample y conditioned on the prompt x. Likewise, the target sequence processing model 102 defines a probability function (based on some policy) π_{θ}(y|x) giving a conditional probability of the sample y conditioned on the prompt x. For brevity, the remainder of this description omits the conditioning on x, but it should be understood that probabilities are computed conditioned on an input or context.

In some approaches (not illustrated in FIG. 1), reward fine-tuning to align the model to a specific task (e.g., which is specified or represented by human preference labels) can be performed by training a reward model on sequences, pairs, or lists or sets of sequences, and then (iteratively) refining (e.g., fine-tuning) the model towards the reward model. Different types of preference models can be trained, but one example is the classical RLHF setup in which preference labels are given on a pair of sequences that were sampled by the reference model in response to the same prompt, and the preference labels indicate that one of the two sequences y_{w} is preferred over the other yₗ.

FIG. 1 illustrates example implementations of the present disclosure that train on pairwise preference labels of the type described above. In particular, the target sequence processing model 102 is trained (e.g. fine-tuned) using a pairwise preference training example 108. The pairwise preference example 108 includes: a prompt 109, a first sequence of tokens 110, a second sequence of tokens 112, and a preference label 114. As one example, the first sequence of tokens 110 and the second sequence of tokens 112 may have both been previously-generated by the reference sequence processing model in response to the prompt 109. As another example, the first sequence of tokens 110 and the second sequence of tokens 112 may have both been previously-generated from some other source of responses, including manually-generated responses. The first sequence of tokens 110 can be represented as y_{w}; and the second sequence of tokens 112 can be represented as yₗ, assuming that the human preference is of the first sequence

As one example, the preference label 114 can have been generated based on a preference or rating provided by a human rater when presented with the first sequence of tokens 110 and the second sequence of tokens 112. As another example, the preference label 114 can have been generated from some other source of rating or labeling including, for example, a trained reward model.

The preference label 114 can be or include one or more label values corresponding to a first non-tied preference event in which the first sequence of tokens 110 is preferred over the second sequence of tokens 112 or a second non-tied preference event in which the second sequence of tokens 112 is preferred over the first sequence of tokens 110. (Though, the preferred sequence is always denoted as y_{w}). As one example, the preference label 114 can be a binary label that indicates a binary preference. To provide an example, a binary preference label value of 1 may correspond to the first non-tied preference event while a label value of 0 or −1 may correspond to the second non-tied preference event. In another example, the preference label 114 can be a fractional label that indicates some fraction of labelers that selected the first non-tied preference event, or, conversely, some fraction of labelers that selected the second non-tied preference event. To provide an example, a fractional preference label of 0.7 could be interpreted as indicating that 70% of labelers selected the first non-tied preference event while 30% of labelers selected the second non-tied preference event.

However, as discussed above, binary or fractional label values that correspond to only the first non-tied preference event or the second non-tied preference event do not align with or provide a complete model of human preference under a single sequence generation model and a binary label preference model. In particular, it is possible (and in fact likely) that some number of raters or labelers do not in fact have a preference between the two sequences. For example, a rater's true preferences (not represented within the preference label 114) may correspond to: a first tied preference event in which neither the first sequence of tokens nor the second sequence of tokens is preferred; or a second tied preference event in which both the first sequence of tokens and the second sequence of tokens are preferred. For example, a rater may view both sequences as strong, positive representations of their preference—a situation that corresponds to the second tied preference event. However, typical preference datasets do not include label values for the tied settings, and instead the preference labels in typical preference datasets correspond only to the first non-tied preference event or the second non-tied preference event.

Referring still to FIG. 1, some example training approaches of the present disclosure can proceed as follows: the target sequence processing model 102 can be queried with the prompt 109 so as to determine or generate two target probabilities 116 and 118 that are respectively generated by the target sequence processing model 102 for the first sequence of tokens 110 and the second sequence of tokens 112. For example, the target probability 116 for the first sequence of tokens 110 can represent the probability that the target sequence processing model 102 would generate the first sequence of tokens 110 in response to the prompt 109. Thus, the target probability 116 can be represented as π_{θ}(y_{w}|x). Similarly, the target probability 118 for the second sequence of tokens 112 can represent the probability that the target sequence processing model 102 would generate the second sequence of tokens 112 in response to the prompt 109. Thus, the target probability 118 can be represented as π_{θ}(yₗ|x).

Similarly, the reference sequence processing model 104 can be queried with the prompt 109 so as to determine or generate two reference probabilities 120 and 122 that are respectively generated by the reference sequence processing model 104 for the first sequence of tokens 110 and the second sequence of tokens 112. For example, the reference probability 120 for the first sequence of tokens 110 can represent the probability that the reference sequence processing model 104 would generate the first sequence of tokens 110 in response to the prompt 109. Thus, the reference probability 120 can be represented as π_{ref}(y_{w}|x). Similarly, the reference probability 122 for the second sequence of tokens 112 can represent the probability that the reference sequence processing model 104 would generate the second sequence of tokens 112 in response to the prompt 109. Thus, the reference probability 122 can be represented as π_{ref}(yₗ|x).

As illustrated in FIG. 1, the preference optimization loss function 106 can determine a loss value based on the probabilities 116, 118, 120, and 122. Example preference optimization loss functions 106 are discussed in the sections that follow. The target sequence processing model 102 can be updated based on the preference optimization loss function 106. As one example, a gradient of the preference optimization loss function 106 can be backpropagated through the target sequence processing model 102 to update one or more values of one or more parameters of the target sequence processing model 102.

Example Pairwise Labels with Ties

Given an assumed pointwise sequence generation model, in order to have a model that matches the labeling procedure, some example implementations can map all events to the labels trained on by the model. Let zϵ{0,1} be an implicit preference label predicted by a pointwise per-sequence preference model. The pairwise setting must consider all events {z_{w},zₖ}ϵ{{0,0},{0,1}, {1,0}, {1,1}}. Since labeling only gives the events {0,1} and {1,0}, where one sequence is preferred over the other, in absence of a better model, some example implementations assume that the predictions of the events {0,0} and {1,1} are uniformly partitioned between the events y_{w}>yₗ and yₗ>y_{w}. In this setting, the ties are accounted for within the prediction model, even though the labels trained on by the model do not allow ties.

For brevity, denote p_{w}∝p_{θ}(z_{w}=1|y_{w}) and pₗ∝p_{θ}(zₗ=1|yₗ), where θ0 is used to denote all parameters of the model. Some example implementations make an independence assumption between these two events. While such assumption may not be entirely accurate for any one particular case, the logistic regression solution applied to the preference model will take care of credit attribution to account for correlation. In addition, a hyperparameter β can be added to the loss to compensate for correlation that is not modeled, but not for model/labeling mismatch. In particular, uniformly dividing the excluded events gives

$${p}_{θ} ( {y}_{w} {y}_{l} ) = {p}_{w} ( 1 - {p}_{l} ) + 0.5 {p}_{w} {p}_{l} + 0.5 ( 1 - {p}_{w} ) ( 1 - {p}_{l} ) = 0.5 ( {p}_{w} + 1 - {p}_{l} ) \qquad ( 1 )$$

Similarly, we have

$${p}_{θ} ( {y}_{l} {y}_{w} ) = 0.5 ( {p}_{l} + 1 - {p}_{w} ) \qquad ( 2 )$$

### Ties Misalignment of the Bradley-Terry Model

RLHF and DPO assume a pairwise Bradley-Terry model in which p_{θ}(y_{w}>yₗ) is computed as the Sigmoid (logistic) function σ(r_{w}−rₗ) of the difference between the logit scores r_{w} and rₗ, representing the logodds of a probability of a positive preference for each of the two sequences, respectively, where σ(·) is the Sigmoid function. This model assumes that p_{w}=σ(r_{w}) and pₗ=σ(rₗ). However, the described assumptions, if they relate to the scores r_{w} and rₗ as logodds of a sequence preference probability, are misaligned with the model in Equations (1)-(2).

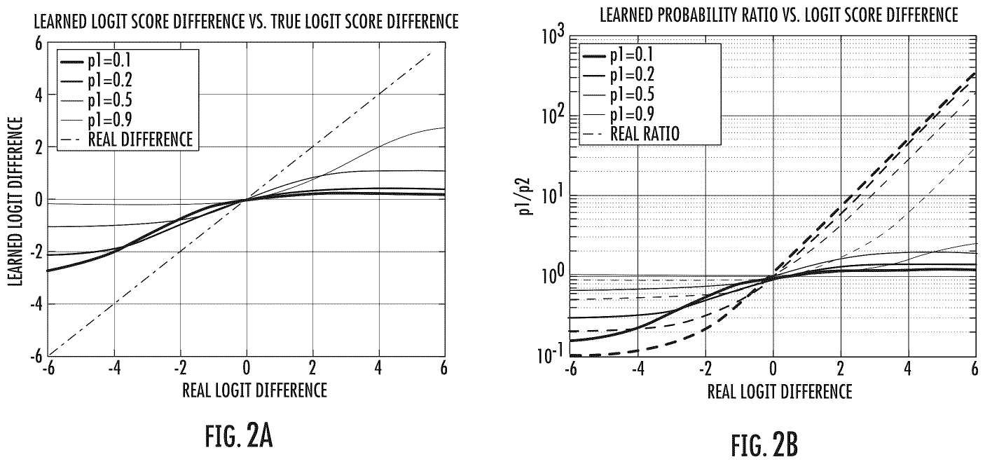

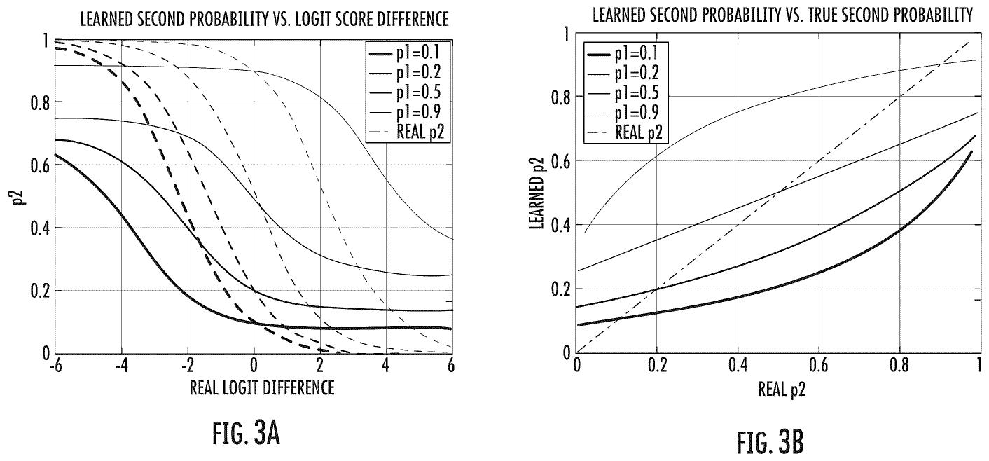

FIGS. 2A and 2B illustrate how this mismatch affects the learned logit score differences and the learned ratio

$$\frac{{p}_{w}}{{p}_{l}}$$

for a set of different values of p_{w} as function of a “true” logit score difference r_{w}−rₗ. Specifically, FIG. 2A illustrates learned logit score difference for r_{w}−rₗ as a function of the “true” difference between two distributions for fixed first distributions (p_{w}=p₁) with a mismatched model trained without accepting ties when preferences are uniformly randomly drawn when there are preference ties. FIG. 2B illustrates the learned ratio

$$\frac{{p}_{w}}{{p}_{l}}$$

as a function of the real logit score differences.

In each of these graphs, the real pointwise (single trajectory) probabilities p_{w}=p₁ and pₗ=p₂ are pre-determined, where p₁ is fixed first and p₂ is described though r₁−r₂, the logit score difference between these two probabilities. The “true” probabilities are used to generate (Bernoulli) preference label sequences, and the Bradley-Terry model is applied to learn estimates for r₁−r₂ (or the ratio of

$$\frac{{p}_{1}}{{p}_{2}} ) .$$

As shown in FIGS. 2A and 2B, this mismatch clearly leads to underestimating the differences and the ratios between the two probabilities. Such underestimation is exacerbated for smaller probabilities of positive preference, and increases with larger logit score differences.

FIGS. 3A and 3B demonstrate the offsets in estimating pₗ for a fixed p_{w} as a function of the true logit score difference and as a function of the true value of pₗ for various values of p_{w}. Specifically, FIG. 3A illustrates learned pₗ=p₂ as a function of the real logit score difference; while FIG. 3B illustrates learned pₗ=p₂ as function of the real value of pₗ for different fixed p_{w}. FIGS. 3A and 3B enhance the illustrations in FIGS. 2A and 2B.

FIGS. 4A-D illustrate how a hyperparameter β, for example as used in methods such as RLHF and DPO, partially offsets the underestimation of the score differences. Specifically, FIG. 4A shows learned r_{w}−rₗ as function of true r_{w}−rₗ; FIG. 4B shows learned

$$\frac{{p}_{w}}{{p}_{l}}$$

as function of true r_{w}−rₗ; FIG. 4C shows pₗ as function of r_{w}−rₗ, and FIG. 4D shows pₗ as function of real pₗ for different fixed p_{w} with β=0.2 scaling of the learned r_{w}−rₗ. Applying β<1 to multiply the learned difference r_{w}−rₗ scales the magnitude of the learned curves in FIGS. 2A-B and 3A-B such that for some values of the true logit score differences they match the true differences. However, this cannot be achieved uniformly.

### Example Approaches for Tied Preference Optimization

This section describes a derivation of an example tied preference optimization loss function that includes a reward function similar to IPO, but is specifically geared to the preference predictions described in equations (1)-(2). A pointwise per-sequence target of an IPO-like optimization maximizes a reward which is a function of the per-sequence probability of a positive preference, regularized by a hyperparameter β weighted KL-divergence between the target and reference distributions

$${π}_{θ} = arg {max}_{{π}_{θ}^{′}} \{ {𝔼}_{x \sim D , y \sim {π}_{θ}^{′} ( y )} \{ {p}_{θ} ( z = 1 \vert y ) \} - β {D}_{KL} ( {π}_{θ}^{′} ( y ) \vert \vert {π}_{ref} ( y ) ) \} \qquad ( 3 )$$

where θ parameterizes the target distribution π_{θ}(·). Solving the optimization gives

$$\begin{matrix}{π}_{θ} = arg {max}_{π} \{ {𝔼}_{x \sim D , y \sim π ( y )} \{ {p}_{θ} ( z = 1 \vert y ) \} - β {D}_{KL} ( π ( y ) \vert \vert {π}_{ref} ( y ) ) \} \\ = arg {max}_{π} {𝔼}_{x \sim D , y \sim π ( y )} \{ {p}_{θ} ( z = 1 \vert y ) - β log π ( y ) + β log {π}_{ref} ( y ) \} \\ = arg {max}_{π} {𝔼}_{x \sim D , y \sim π ( y )} \{ log \frac{π ( y )}{{π}_{ref} ( y ) \cdot exp [ \frac{{p}_{θ} ( z = 1 \vert y )}{β} ]} \}\end{matrix} \qquad ( 4 )$$

The solution to (4) satisfies

$${π}_{θ} ( y ) ∝ {π}_{ref} ( y ) \cdot exp [ \frac{{p}_{θ} ( z = 1 \vert y )}{β} ] \qquad ( 5 )$$

Applying a partition function Z summing over all y gives

$${π}_{θ} ( y ) = \frac{1}{Z} \cdot {π}_{ref} ( y ) \cdot exp [ \frac{{p}_{θ} ( z = 1 \vert y )}{β} ] \qquad ( 6 )$$

Similarly to the DPO analysis, we can now express the positive preference probability in term of the target and reference distributions, giving

$${p}_{θ} ( z = 1 \vert y ) = β \cdot log \frac{{π}_{θ} ( y ) \cdot Z}{{π}_{ref} ( y )} \qquad ( 7 )$$

where we must ensure that p_{θ}(z=1|y)ϵ[0,1]. Plugging (7) to the probability of preferring y_{w} over yₗ in (1) gives

$$\begin{matrix}{p}_{θ} ( {y}_{w} ≻ {y}_{l} ) = 0.5 \cdot \{ 1 + {p}_{θ} ( z = 1 \vert {y}_{w} ) - {p}_{θ} ( z = 1 \vert {y}_{l} ) \} \\ = 0.5 \cdot \{ 1 + β log \frac{{π}_{θ} ( {y}_{w} )}{{π}_{ref} ( {y}_{w} )} - β log \frac{{π}_{θ} ( {y}_{l} )}{{π}_{ref} ( {y}_{l} )} \}\end{matrix} \qquad ( 8 )$$

Again, the difference of probabilities must be in [−1,1]. Applying a negative logarithm of the probability loss, gives

$$\begin{matrix}{L}_{TPO} ( {π}_{θ} ; {π}_{ref} ) = - {𝔼}_{( {y}_{w} , {y}_{l} ) ∼ 𝒟} [ log \{ 2 \cdot {p}_{θ} ( {y}_{w} ≻ {y}_{l} ) \} ] \\ = - {𝔼}_{( {y}_{w} , {y}_{l} ) ∼ 𝒟} [ log ( 1 + βlog \frac{{π}_{θ} ( {y}_{w} )}{{π}_{ref} ( {y}_{w} )} - β log \frac{{π}_{θ} ( {y}_{l} )}{{π}_{ref} ( {y}_{l} )} ) ]\end{matrix} \qquad ( 9 )$$

where the factor of 2 is applied for simplicity of the expression in (9) (it does affect the value of the loss, but does not affect the gradient which is actually used in the optimization).

Given that the Softmax function constrains the target probability, it may be possible to minimize (9) without enforcing the probability constraints that emerge from (7) for upper bounding the expression inside the logarithm in (9). This expression, however, should be bounded from below. It can be clipped between [ε, 2−ε], adjusting the gradients at the boundaries. For a small β<1, clipping at ε=β will bound the magnitude of the gradients on the logits scores of both sequences by 1.

In addition, to upper bound the expression inside the logarithm, denoted by ρ, a barrier function regularizer of −log(2−ρ) can be added to the objective with some weight δ, which would regularize (9) with a term that reverses the signs of the arguments inside the logarithm, essentially acting as label smoothing, by giving a fraction of the label to the opposite event.

### Further Example Loss Functions

As described above, the loss in Equation (9) is sensitive to the learned distribution π_{θ}(y). Without clipping or regularization by a barrier function, the argument inside the logarithm can temporarily take values below 0, causing numerical instability. Even when greater than 0, but close, there can be very large gradients. Instead of using a cross entropy loss as in (9), some example implementations can use a different loss.

A proper loss will match the expected distribution of the pairwise preference label. A simple proper loss alternative is a square loss, which, by the nature of the expression that is matched, can be applied in the pairwise probability domain:

$$\begin{matrix}{L}_{2 - TPO} ( {π}_{θ} ; {π}_{ref} ) = - {𝔼}_{( {y}_{w} , {y}_{l} ) ∼ 𝒟} [ {\{ 4 \cdot ( {p}_{θ} ( {y}_{w} ≻ {y}_{l} ) - 1 ) \}}^{2} ] \\ = - {𝔼}_{( {y}_{w} , {y}_{l} ) ∼ 𝒟} [ {( βlog \frac{{π}_{θ} ( {y}_{w} )}{{π}_{ref} ( {y}_{w} )} - β log \frac{{π}_{θ} ( {y}_{l} )}{{π}_{ref} ( {y}_{l} )} - 1 )}^{2} ]\end{matrix} \qquad ( 10 )$$

This loss can be clipped at 0 if the probability of a positive pairwise label (e.g., of 1) exceeds the label. Let [x]_∝min(x, 0) be the minimum between x and 0. Then, the loss of (10) can be replaced by

$${L}_{2 C - TPO} ( {π}_{θ} ; {π}_{ref} ) = {𝔼}_{( {y}_{w} , {y}_{l} ) ∼ 𝒟} [ {( {[ βlog \frac{{π}_{θ} ( {y}_{w} )}{{π}_{ref} ( {y}_{w} )} - β log \frac{{π}_{θ} ( {y}_{l} )}{{π}_{ref} ( {y}_{l} )} - 1 ]}_{-} )}^{2} ] \qquad ( 11 )$$

The loss in (11) guarantees that a loss of 0 is applied if the prediction for the pairwise preference label exceeds the label in the probability domain.

The losses in (10)-(11) match the predicted probability of y_{w} being preferred over yₗ to a preference label of 1 indicating such a preference. In some implementations, fractional preference labels are present that average among multiple raters or over finer grained rater preferences. Let the labeler preference between y_{w} and yₗ be denoted by qϵ[0,1]. Then, the expected loss can be computed for this pair by applying probability q on (10) with y_{w} being preferred over yₗ and applying probability 1−q on (10), reversing roles between y_{w} and yₗ. A square loss of the predicted preference probability against q is a different loss, but has the same gradient. Thus (10) can be replaced by

$${L}_{2 - TPO} ( {π}_{θ} ; {π}_{ref} ) = {𝔼}_{( {y}_{w} , {y}_{l} ) ∼ 𝒟} [ {( \frac{β}{2} log \frac{{π}_{θ} ( {y}_{w} )}{{π}_{ref} ( {y}_{w} )} - \frac{β}{2} log \frac{{π}_{θ} ( {y}_{l} )}{{π}_{ref} ( {y}_{l} )} + \frac{1}{2} - q )}^{2} ] \qquad ( 12 )$$

A similar argument can be used to modify (11) to a loss similar to (12), which is clipped similarly to (11).

The general approach leading to Equation (9) can be matched with various fitting losses that fit the actual pairwise labels to the preference predictions, and implicitly fine-tune the target distribution. In (10)-(12), proper losses were considered that give the same minimum in average as (9). However, some example implementations can also use other losses that may give different minima. One example is a median regression L1 loss on the fractional predictions q. Replacing (12) by

$${L}_{1 - TPO} ( {π}_{θ} ; {π}_{ref} ) = {𝔼}_{( {y}_{w} , {y}_{l} ) ∼ 𝒟} \vert \frac{β}{2} log \frac{{π}_{θ} ( {y}_{w} )}{{π}_{ref} ( {y}_{w} )} - \frac{β}{2} log \frac{{π}_{θ} ( {y}_{l} )}{{π}_{ref} ( {y}_{l} )} + \frac{1}{2} - q \vert \qquad ( 13 )$$

will push the learned pairwise label to the median of the pairwise preferences instead of the mean. Such a loss may be desirable in cases where ratings are noisy with sometimes unreasonable outliers that should be smoothed out. More general quantile losses can also be applied, as well as a Huber loss, which trades off between a square loss and an L1 loss, eliminating outliers but also moving the optimum closer to the mean.

The losses described in (9)-(13) can be applied per-prefix, token by token, instead of per-sequence. Unlike the per-sequence approach for DPO and Equation (8) above, the partition function in the per-token approach may not cancel. However, it can be computed for each of the terms using the Bayesian approach, which considers the target π_{θ}(·) a posterior probability of the next token conditioned on the preference. This probability can be expressed in terms of joint token/positive preference label probability, which can be updated sequentially.

### Generalized Preference Optimization Framework

The methodology used in the sections above to derive TPO can be generalized. The objective in (3) maximizes some function of the single-trajectory pointwise preference with a regularization that matches the target distribution with the reference one. For DPO, the function of the preference is the logit score that is learned for the probability of a sequence having a positive preference. In the IPO paper and in subsequent related work, the objective is a general function of the probability of positive preference learned for the sequence, where specifically for the IPO derivation, it is the probability of a positive preference label.

Let ψ(y) be defined as a function of the learned per-sequence (single-trajectory) expected probability of a positive preference. In all of the prior approaches, the regularization term that matches the target distribution with the reference one is the KL-divergence D_{KL}(π_{θ}∥π_{ref}). According to an aspect of the present disclosure, this distance measure can be replaced by any other type of distance measure, and the same derivation can be applied to derive a different objective.

Let L_{R}(π_{θ}∥π_{ref}) denote some distance measure between the two distributions. Then, we can write a general objective as

$${π}_{θ} = arg {max}_{{π}_{θ}^{′}} \{ {𝔼}_{x ∼ 𝒟 , y ∼ {π}_{θ}^{′} ( y )} \{ ψ ( y ) \} - β {L}_{R} [ {π}_{θ}^{′} , {π}_{ref} ] \} \qquad ( 14 )$$

A key step in both DPO and IPO is that a partition function (or a constrained parameter), that results from the optimization, and is intractable to compute over the set of sequences, can additively cancel out when considering the pairwise relation. For DPO, ψ(y)=r(y)=log[p_{θ}(z=1|y)]−log[p_{θ}(z≠1|y)]. Then, with the Bradley-Terry ranking models, ψ(y_{w})−ψ(yₗ)=r(y_{w})−r(yₗ). The logodds difference is then substituted by a function of the target and reference that emerges from the regularizer, canceling the additive unknown value. With IPO and TPO, ψ(y_{w})−ψ(yₗ)=p_{θ}(z_{w}=1|y_{w})−p_{θ}(zₗ=1|yₗ)≡p_{w}−pₗ giving the probability difference. Similarly to DPO, if the regularization term leads to an additive unknown constraint term, this term can cancel out when expressing the positive preference probability difference. For DPO, the logit score difference is plugged into the expression that computes the conditional probability of y_{w} being preferred over yₗ conditioned on the event that one sequence is preferred over the other. With IPO and TPO, the expression for the probability difference can be plugged into the expected probability of one sequence being preferred over the other in (1)-(2) for which ties are broken arbitrarily uniformly between the two preferences. With a binary labeled preference model, the expression for DPO can be applied only on events where there is clear preference while dropping all ties, whereas the expression for IPO and TPO can be applied to every event.

The last step is applying the score difference or probability difference to some loss. In DPO, the Sigmoid is used to convert the logit difference to probability, and then cross entropy loss is applied. For IPO, square loss is applied to match the predicted probability with the true probability, where the true probability for a sequence pair in which y_{w} is preferred over yₗ is 1 for p(y_{w}>yₗ). Equation (9) gives a cross entropy loss for a similar setting, (10) gives a square loss, and (11) gives a hinged square loss that is clipped for predictions that exceed the label. Other losses can be applied, as well, in both cases. For example, for the DPO case, a modification can be to apply a square loss between the learned logit score difference and the label. However, if the preference labels are only in {0,1}, the label for r(y_{w})−r(yₗ) is infinite. In practice, though, preference labels are averaged over multiple raters, giving labels that can be mapped into [0,1]. Taking the inverse Sigmoid of these labels, some example implementations can then use a square loss for an objective similar to DPO, matching the logit score differences. However, this is matched with the generation model and a binary labeled preference model only if the loss is applied, omitting all cases where labels indicate ties.

The generalized approach outlined above can be summarized in the following steps:

First, choose ψ(y) for the reward that is additive in some domain, and for which there is a ranking metric that can be expressed as a difference in the same domain.

Second, choose L_{R}(π_{θ}, π_{ref}) whose gradient is additive in the same domain as ψ(y).

Third, solve (14) for π_{θ}(y). Lagrange multipliers can be used to express the constraint Σ_{y} π_{θ}(y)=1. With a good choice of L_{R}(π_{θ}, π_{ref}) there is no need to solve for the constraint, as it will cancel out. (Note that there should also be guarantees that the constraints π_{θ}(y)≥0 are satisfied and the relevant Karush-Kuhn-Tucker multipliers applied to constrain these inequalities are zero).

Fourth, express ψ(y_{w})−ψ(yₗ) in terms of the solution.

Fifth, apply a pairwise loss (e.g., cross Entropy, square, hinge, median, or other) to match the difference to the pairwise preference labels in the correct domain, with the correct labeling alignment (IPO/TPO with probability difference over all sequence pairs, DPO with logit score difference over pairs in which one sequence is “truly” preferred over the other).

In some permutations, L_{R}(π_{θ}, π_{ref})=D_{KL}(π_{θ}∥π_{ref}). The following sections show similar approaches with different regularizers L_{R}(π_{θ},π_{ref}).

### Example Cross Entropy Regularizer

Some example approaches regularize towards the KL divergence between the target and the reference. The KL divergence tends to infinity if there is y for which the second term of the KL divergence π_{ref}(y) is small, and if the first probability is large. This holds the model from setting high probability to sequences that have not been seen in the reference data, but receive high preference scores from human raters (if such are able to propagate to the fine-tuning data—which can happen when there are human rewrites corrected generations in fine-tuning).

Regularizing towards the reverse KL divergence avoids this limitation. On the other hand, it limits suppressing high frequency sequences that have low human preference scores. Regularizing to the reverse KL divergence is identical to regularizing towards a cross entropy loss that “distills” the reference predictions as labels towards the target distribution (because the optimization ignores the numerator in the KL divergence).

Substituting

$${L}_{R} [ {π}_{θ} , {π}_{ref} ] = - {\sum }_{y} {π}_{ref} ( y ) log {π}_{θ} ( y ) \qquad ( 15 )$$

in (14), gives an objective of

$${π}_{θ} = arg {max}_{{π}_{θ}^{′}} \{ {𝔼}_{x ∼ 𝒟 , y ∼ {π}_{θ}^{′} ( y )} \{ ψ ( y ) \} + β {\sum }_{y} {π}_{ref} ( y ) log {π}_{θ}^{′} ( y ) \} \qquad ( 16 )$$

Negating the argument of (16), subtracting a Lagrange multiplier constraint term of λ·{Σ_{y} π_{θ}(y)—₁}, ensuring that the Karush-Kuhn-Tucker conditions force the inequality constraints' coefficients to 0, and differentiating w.r.t. π_{θ}(y) gives

$$- B \frac{{π}_{ref} ( y )}{{π}_{θ} ( y )} - ψ ( y ) - λ = 0 \qquad ( 17 )$$

Equation (17) gives the substitution

$$ψ ( y ) = - B \frac{{π}_{ref} ( y )}{{π}_{θ} ( y )} + λ \qquad ( 18 )$$

For a DPO like reward function, (18) gives

$$r ( {y}_{w} ) - r ( {y}_{l} ) = β \frac{{π}_{ref} ( {y}_{l} )}{{π}_{θ} ( {y}_{l} )} - β \frac{{π}_{ref} ( {y}_{w} )}{{π}_{θ} ( {y}_{w} )} \\ yielding \qquad ( 19 )$$

$${p}_{θ} ( {y}_{w} ≻ {y}_{l} ) = \frac{1}{1 + exp ( β \frac{{π}_{ref} ( {y}_{w} )}{{π}_{θ} ( {y}_{w} )} - β \frac{{π}_{ref} ( {y}_{l} )}{{π}_{θ} ( {y}_{l} )} )} \qquad ( 20 )$$

With a cross entropy loss applied to match preference labels where one sequence is preferred over the other, this gives a loss of

$$L ( {π}_{θ} ; {π}_{ref} ) = {𝔼}_{( {y}_{w} ≻ {y}_{l} ) ∼ 𝒟} [ log σ ( β \frac{{π}_{ref} ( {y}_{l} )}{{π}_{θ} ( {y}_{l} )} - β \frac{{π}_{ref} ( {y}_{w} )}{{π}_{θ} ( {y}_{w} )} ) ] \qquad ( 21 )$$

where y_{w}>yₗ is used in the expectation to denote that the expectation is applied conditioned on the event that one sequence (y_{w}) is preferred over the other (yₗ).

If we choose ψ(y)=p_{θ}(z=1|y), (19) becomes

$${p}_{ω} - {p}_{l} = β \frac{{π}_{ref} ( {y}_{l} )}{{π}_{θ} ( {y}_{l} )} - β \frac{{π}_{ref} ( {y}_{w} )}{{π}_{θ} ( {y}_{w} )} \qquad ( 22 )$$

Substituting in (1),

$${p}_{θ} ( {y}_{w} ≻ {y}_{l} ) = \frac{1}{2} \cdot [ 1 + β \frac{{π}_{ref} ( {y}_{l} )}{{π}_{θ} ( {y}_{l} )} - β \frac{{π}_{ref} ( {y}_{w} )}{{π}_{θ} ( {y}_{w} )} ] \qquad ( 23 )$$

The probability in Equation (23) can be matched to the preference labels with a cross entropy loss like that in (9), with a square loss as in (10), with a clipped square loss as in (11), with a median L₁ loss as in (13), or with another loss. Specifically for the square loss, we have

$$L ( {π}_{θ} ; {π}_{ref} ) = \text{?} [ {( β \frac{{π}_{ref} \text{?}}{{π}_{θ} \text{?}} - β \frac{{π}_{ref} \text{?}}{{π}_{θ} \text{?}} - 1 )}^{2} ] \qquad ( 24 )$$

$$\text{?} \text{indicates text missing or illegible when filed}$$

If fractional preference labels are provided, the loss in (24) can be applied to both directions with a fractional probability, or a similar variation of (23)-(24) to that in (12) can be derived.

### Example Mixing Divergence Regularizers (Generalization of Jeffrey's Divergence)

The benefits of both divergences can be combined by mixing them with

$${π}_{θ} = arg m \text{?} x \{ \text{?} \{ ψ ( y ) - α β {D}_{KL} ( \text{?} ‖ {π}_{ref} ) - ( 1 - α ) β {D}_{KL} ( {π}_{ref} ‖ \text{?} ) \} \qquad ( 25 )$$

$$\text{?} \text{indicates text missing or illegible when filed}$$

This objective gives

$$( 26 )$$

$$ψ ( {y}_{w} ) - ψ \text{?} = β \cdot \{ α \cdot [ log \frac{{π}_{θ} ( {y}_{w} )}{{π}_{ref} ( {y}_{w} )} - log \frac{{π}_{θ} ( \text{?} )}{{π}_{ref} ( \text{?} )} ] + ( 1 - α ) \cdot [ \frac{{π}_{ref} ( \text{?} )}{{π}_{θ} ( \text{?} )} - \frac{{π}_{ref} ( {y}_{w} )}{{π}_{θ} ( {y}_{w} )} ] \}$$

$$\text{?} \text{indicates text missing or illegible when filed}$$

The difference in (26) can be applied as an argument of the Sigmoid in (21) giving a DPO like loss. It can be substituted in (1) giving a similar to the TPO probability in (8) and (23) leading to losses as in (9)-(12) and (24). Specifically, the right hand side of (26) can replace the first two terms in (24), to give a square mixed loss.

### Example Jensen-Shannon Divergence Regularizer

A more uniform regularizer can be obtained by a generalized form of the Jensen-Shannon divergence

$${D}_{JSD} ( {π}_{θ} ‖ {π}_{ref} ) {=}^{△} α {D}_{KL} [ {π}_{θ} ‖ α {π}_{θ} + ( 1 - α ) {π}_{ref} ] + ( 1 - α ) {D}_{KL} [ {π}_{ref} ‖ α {π}_{θ} + ( 1 - α ) {π}_{ref} ] \qquad ( 27 )$$

For the standard form, α=0.5. This measure moderates both extreme cases allowing both the target probability of a sequence to become much larger than the reference one, or to become much smaller than a large reference. Yet, this approach does preserve more moderate non-uniformity among the different sequence probabilities, still pushing for the target to prefer sequences whose reference probabilities are large.

Substituting the regularizer in (27) in the general objective of (14) gives the solution

$$\begin{matrix}ψ ( {y}_{w} ) - ψ \text{?} = β \cdot α \cdot \{ log \frac{{π}_{θ} ( {y}_{w} )}{α {π}_{θ} ( {y}_{w} ) + ( 1 - α ) {π}_{ref} ( {y}_{w} )} - log \frac{{π}_{θ} ( \text{?} )}{α {π}_{θ} ( \text{?} ) + ( 1 - α ) {π}_{ref} ( \text{?} )} \} \\ = β \cdot α \cdot \{ log [ α + ( 1 - α ) \frac{{π}_{ref} ( \text{?} )}{{π}_{θ} ( \text{?} )} ] - log [ α + ( 1 - α ) \frac{{π}_{ref} ( {y}_{w} )}{{π}_{θ} ( {y}_{w} )} ] \}\end{matrix} \qquad ( 28 )$$

$$\text{?} \text{indicates text missing or illegible when filed}$$

For α=0.5, this gives

$$ψ ( {y}_{w} ) - ψ ( \text{?} ) = \frac{β}{2} \cdot \{ log [ 1 + \frac{{π}_{ref} ( \text{?} )}{{π}_{θ} ( \text{?} )} ] - log [ 1 + \frac{{π}_{ref} ( {y}_{w} )}{{π}_{θ} ( {y}_{w} )} ] \} \qquad ( 29 )$$

$$\text{?} \text{indicates text missing or illegible when filed}$$

As in the other cases, (29) can be applied to the logit score difference or to the probability difference of the preference scores of both sequences, and plugged into different loss forms, such as cross entropy, square, clipped square, hinge, median, or others. With a probability difference (such as TPO),

$$p θ ( {y}_{w} \text{?} ) = \frac{1}{2} + \frac{β}{4} \cdot log [ 1 + \frac{{π}_{ref} ( \text{?} )}{{π}_{θ} ( \text{?} )} ] - \frac{β}{4} \cdot log [ 1 + \frac{{π}_{ref} ( {y}_{w} )}{{π}_{θ} ( {y}_{w} )} ] \qquad ( 30 )$$

$$\text{?} \text{indicates text missing or illegible when filed}$$

Matching the probability in (30) with a square loss against a positive label, we obtain a loss

$$( 31 )$$

$$L ( {π}_{θ} ; {π}_{ref} ) = \text{?} [ {( \frac{β}{4} \cdot log [ 1 + \frac{{π}_{ref} ( \text{?} )}{{π}_{θ} ( \text{?} )} ] - \frac{β}{4} \cdot log [ 1 + \frac{{π}_{ref} ( {y}_{w} )}{{π}_{θ} ( {y}_{w} )} ] - \frac{1}{2} )}^{2} ]$$

$$\text{?} \text{indicates text missing or illegible when filed}$$

which can be scaled to

$$( 32 )$$

$$L ( {π}_{θ} ; {π}_{ref} ) = \text{?} [ {( \frac{β}{2} \cdot log [ 1 + \frac{{π}_{ref} ( \text{?} )}{{π}_{θ} ( \text{?} )} ] - \frac{β}{2} \cdot log [ 1 + \frac{{π}_{ref} ( {y}_{w} )}{{π}_{θ} ( {y}_{w} )} ] - 1 )}^{2} ]$$

$$\text{?} \text{indicates text missing or illegible when filed}$$

With fractional preference labels, (31) can be applied with the fractional probabilities of both preference directions, or instead, a similar loss to (12) can be obtained by replacing −0.5 in (31) by 0.5−q (which an be scaled to 1−2q for (32)).

### Example Lₚ Regularizer

Instead of divergence-based regularizers, norm-based regularizers can be applied. They guarantee uniform regularization across the domain on which they are applied, and mitigate the extreme cases with KL-divergence based regularizers. They may be more suited to apply in the logit domain than in the probability domain due to potentially very small preference probability differences, but even in the probability domain they may allow the preference model to better diverge away from the reference in cases where either the reference or the target have small sequence probabilities.

The general objective in (14) becomes

$${π}_{θ} = arg m \text{?} x \{ \text{?} \{ ψ ( y ) \} - β \cdot {‖ \text{?} - {π}_{ref} ‖}^{ρ} \} \qquad ( 33 )$$

$$\text{?} \text{indicates text missing or illegible when filed}$$

where ρ is the Lₚ norm (excluding L₀ and L_{∞}). This gives

$$ψ ( y ) = βρ \cdot \{ sign \{ {π}_{θ} ( y ) - {π}_{ref} ( y ) \} \cdot {\vert {π}_{θ} ( y ) - {π}_{ref} ( y ) \vert}^{ρ - 1} \} - λ \qquad ( 34 )$$

Note that in this case, we may not be able to cancel the additional Karush-Kuhn-Tucker coefficients for the target π_{θ}(y)≥0 in cases for which they are not 0, which enforce π_{θ}(y)=0 in cases in which the unconstrained optimum is obtained at π_{θ}(y)<0. However, these coefficients, when they are not 0, can be absorbed into the reward function ψ(y). This will change the actual reward function, but will give an identical solution to the one with the constraints, but for which all the inequality constraint coefficients are 0.

The effect on the reward does not change the reward difference expression in terms of the reference and target distributions. In many cases, it should not change the loss applied to fit the preference labels. However, in cases in which the reward function is the preference probability, absorbing non-zero Karush-Kuhn-Tucker inequality coefficients in the reward violates the definition of the reward as a probability. This invalidates fitting the preference labels with a cross entropy loss that expects a probability.

However, applying a square loss or other losses with the modified rewards is still valid for just fitting the preference labels to the modified reward. Using softmax per each token of the target sequence implicitly also constrains the sequence probabilities to π_{θ}(y)>0 and to not go below 0. For sequence pairs for which π_{θ}(y)>0, the inequality Karush-Kuhn-Tucker coefficients will be 0, and the coefficients of other values of y will still cancel out with the λ coefficient. In any of the cases, this gives the preference score difference of

$$ψ ( {y}_{w} ) - ψ ( \text{?} ) = βρ \cdot \{ sign \{ {π}_{θ} ( {y}_{w} ) - {π}_{ref} ( {y}_{w} ) \} \cdot {\vert {π}_{θ} ( {y}_{w} ) - {π}_{ref} ( {y}_{w} ) \vert}^{ρ - 1} - sign \{ {π}_{θ} ( \text{?} ) - {π}_{ref} ( \text{?} ) \} \cdot {\vert {π}_{θ} ( \text{?} ) - {π}_{ref} ( \text{?} ) \vert}^{ρ - 1} \} \qquad ( 35 )$$

$$\text{?} \text{indicates text missing or illegible when filed}$$

For probability difference and L₂ norm, this gives

$$p θ ( {y}_{w} \text{?} ) = \frac{1}{2} + β \cdot \{ {π}_{θ} ( {y}_{w} ) - {π}_{ref} ( {y}_{w} ) - {π}_{θ} ( \text{?} ) + {π}_{ref} ( \text{?} ) \} \qquad ( 36 )$$

$$\text{?} \text{indicates text missing or illegible when filed}$$

where p_{θ}(y_{w}>yₗ) may be outside the interval [0,1] in cases where the inequality Karush-Kuhn-Tucker coefficients are not 0 for either y_{w}, yₗ, or both. However, a square loss can be applied regardless, given by

$$L ( {π}_{θ} ; {π}_{ref} ) = \text{?} [ {( β \cdot \{ {π}_{θ} ( {y}_{w} ) - {π}_{ref} ( {y}_{w} ) - {π}_{θ} ( \text{?} ) + {π}_{ref} ( \text{?} ) \} - \frac{1}{2} )}^{2} ] \qquad ( 37 )$$

$$\text{?} \text{indicates text missing or illegible when filed}$$

Similarly to (12), with fractional preference labels, −1/2 can be replaced by 1/2−q giving

$$L ( {π}_{θ} ; {π}_{ref} ) = \text{?} [ {( β \cdot \{ {π}_{θ} ( {y}_{w} ) - {π}_{ref} ( {y}_{w} ) - {π}_{θ} ( \text{?} ) + {π}_{ref} ( \text{?} ) \} + \frac{1}{2} - q )}^{2} ] \qquad ( 38 )$$

$$\text{?} \text{indicates text missing or illegible when filed}$$

### Example Methods

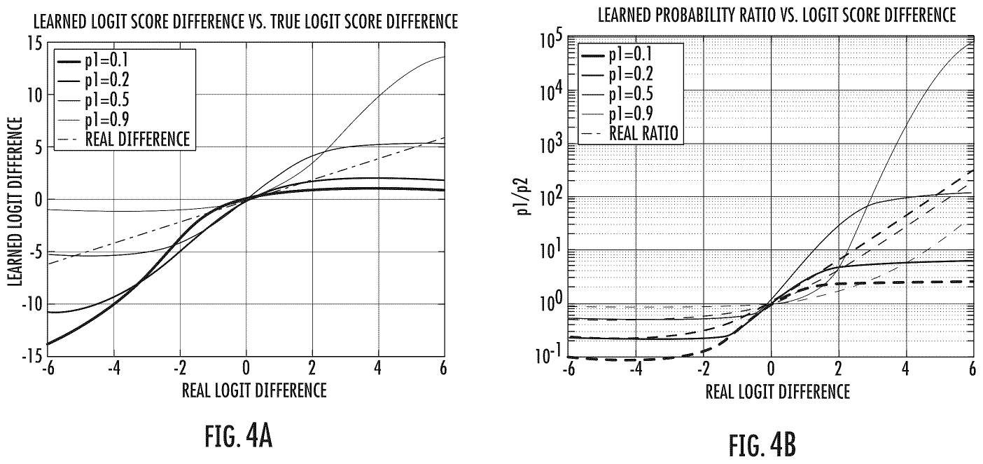

Referring to FIG. 5, an example method 500 initiates at step 502, where a computing system obtains a pairwise preference training example. The training example comprises a first sequence of tokens, a second sequence of tokens, and a pairwise preference label. The pairwise preference label includes one or more label values that are indicative of a first non-tied preference event in which the first sequence of tokens is preferred over the second sequence of tokens, or a second non-tied preference event where the second sequence of tokens is preferred over the first sequence of tokens.

At step 504, the computing system evaluates a tied preference optimization loss function. This loss function includes a pairwise preference probability expression that represents the likelihood of the first non-tied preference event occurring. The expression can result from distributing probabilities associated with a first tied preference event and a second tied preference event the label values for the non-tied preference events. The first tied preference event is characterized by neither sequence of tokens being preferred, while the second tied preference event is characterized by both sequences of tokens being preferred.

Subsequently, at step 506, the computing system modifies one or more values of one or more parameters of a target sequence processing model based on the evaluation of the tied preference optimization loss function. This modification can involve adjusting the parameters to minimize the loss function, thereby aligning the model's outputs more closely with human preferences as indicated by the training data.

In some implementations, the computing system may perform additional steps to enhance the fine-tuning process. For example, the system can perform the method 500 to iteratively update the model parameters. The method may further include iterating one or multiple times in validating the modified model against a separate set of preference data to evaluate the effectiveness of the fine-tuning and make further adjustments if necessary.

The described method can be implemented in various computing environments, including cloud-based systems, local servers, or specialized machine learning platforms. The TPO framework can be adapted to different model architectures and can be integrated into existing machine learning workflows to improve the relevance and quality of generated content for end-users.

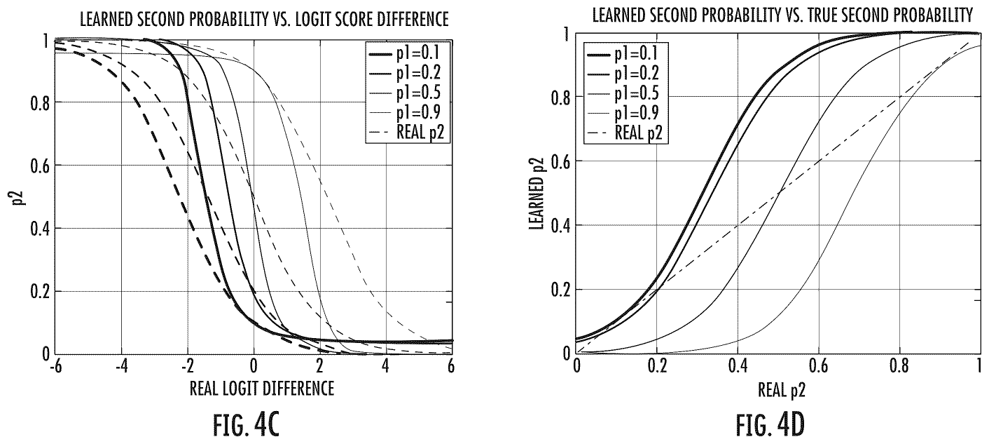

FIG. 6 illustrates a flow chart diagram of an example method 600 for a preference optimization loss function within a preference optimization framework. The method begins at step 602, where a reward function, a regularizer, and a pairwise loss function are selected for utilization in generation of the preference optimization loss function. The reward function can be chosen based on the specific characteristics of the input data or desired output properties of the model. For example, the reward function can be a logit score of the probability of a positive outcome, a direct probability score itself, or other measures of reward. The regularizer can be selected to prevent overfitting and to ensure generalization of the model; example choices include L2 regularization, KL divergence, reverse KL divergence, a Jensen-Shannon divergence, other distances measures, or combinations thereof. As further examples, the pairwise loss function could be a cross-entropy loss, square loss, median loss, hinge loss, or other losses.

At step 604, the method includes optimizing a single-sequence generation objective that maximizes the selected reward function while applying regularization according to the selected regularizer. This optimization process results in a solution expression for the selected reward function. For example, the solution expression can be a function of a target probability associated with a target sequence processing model and a reference probability associated with a reference sequence processing model.

In step 606, a pairwise reward difference is expressed between the solution expression applied to two different sequences of tokens. For example, this can include expressing the difference in the expected rewards for two different sequences, where each sequence's reward is computed using the solution expression derived from the optimization step.

At step 608, a preference optimization loss function is generated by applying the selected pairwise loss function to fit the pairwise reward difference to a human preference label. This can include using the pairwise reward difference calculated in step 606 and fitting this difference to the actual preferences indicated by human labels using the selected loss function.

Finally, in step 610, the generated preference optimization loss function is used to train a sequence processing model. This training can include feeding sequences of tokens into the model, applying the model to generate outputs, calculating the preference optimization loss for these outputs, and then using this loss to update the model's parameters. This step can be performed multiple times over many iterations or epochs to sufficiently train the model. This training process refines the model's parameters so that its outputs increasingly align with human preferences, as defined by the training data.

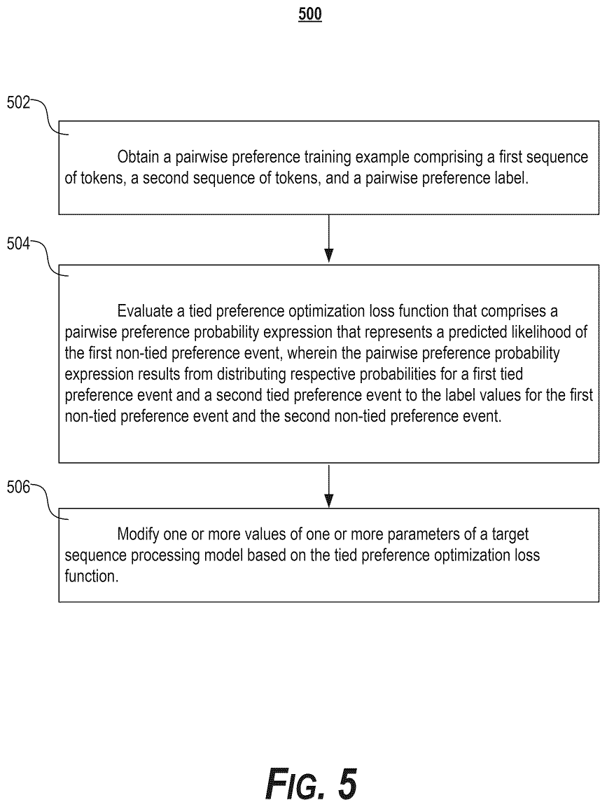

FIG. 7 illustrates a flow chart diagram of an example method 700 for generating a preference optimization loss function designed to fine-tune sequence processing models in alignment with human preferences. The method begins at step 702, where a general objective is obtained. This objective comprises a reward function of a learned per-sequence expected probability of a positive preference, as well as a distance measure applied between a target distribution of the target sequence processing model and a reference distribution of a reference sequence processing model.

At step 704, the method includes solving the general objective for a solution expression of the target distribution of the target sequence processing model for a particular output sequence of tokens.

Proceeding to step 706, the method includes expressing, in terms of the solution expression, a difference between the reward function applied to a first sequence of tokens and the reward function applied to a second sequence of tokens. This step quantifies the distinction in preference between two sequences, which helps train the model to discern between more and less preferred outcomes.

Finally, at step 708, a pairwise loss is applied to match the difference to a pairwise preference label associated with the first sequence of tokens and the second sequence of tokens. This loss function serves to adjust the model parameters in a way that minimizes the discrepancy between predicted and actual human preferences.

In some implementations, the reward function includes a preference probability score, and the pairwise loss comprises a cross entropy loss. The distance measure can take various forms, including but not limited to a reverse KL divergence, a cross entropy regularizer, a combination of a KL divergence and a reverse KL divergence, a Jensen-Shannon divergence, or an Lp regularizer, excluding L zero and L infinity.

Furthermore, the pairwise loss can include different types of losses such as a cross entropy loss, a square loss, or a hinge loss, a median loss, depending on the specific implementation and the desired characteristics of the fine-tuning process.

The preference optimization loss function can evaluate first and second target probabilities respectively generated by the target sequence processing model for the first and second sequences of tokens. It can also evaluate first and second reference probabilities respectively generated by the reference sequence processing model for the first and second sequences of tokens. This allows the method to effectively fine-tune the target model based on an understanding of both the target and reference behaviors in relation to human preferences.

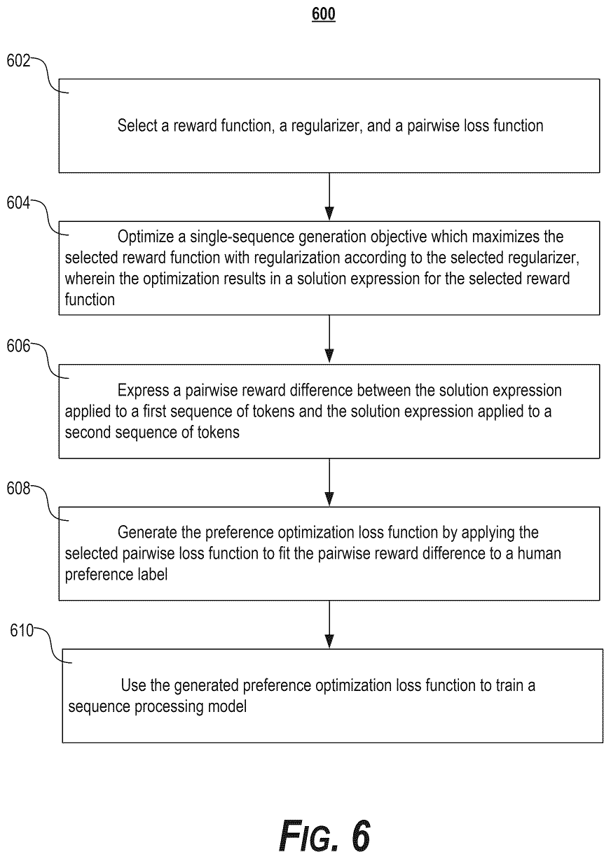

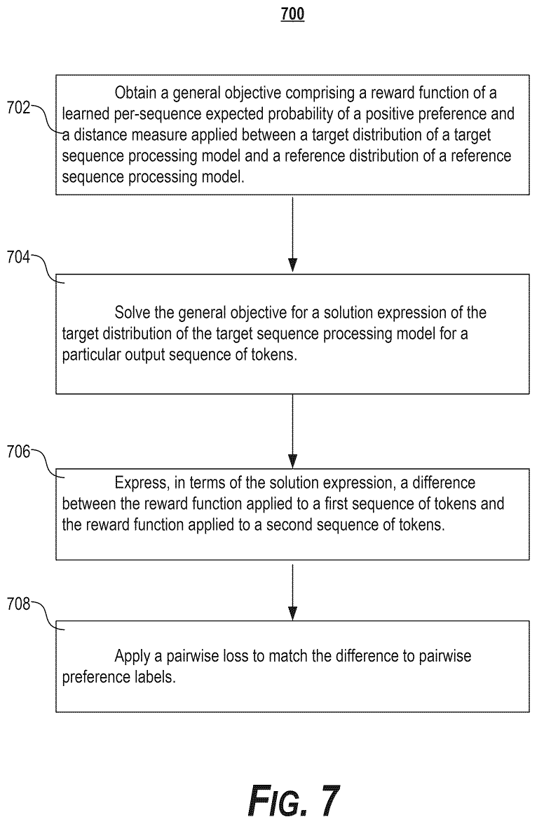

FIG. 8 depicts a flowchart of a method 800 for training one or more machine-learned models according to aspects of the present disclosure. For instance, an example machine-learned model can include a sequence processing model.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

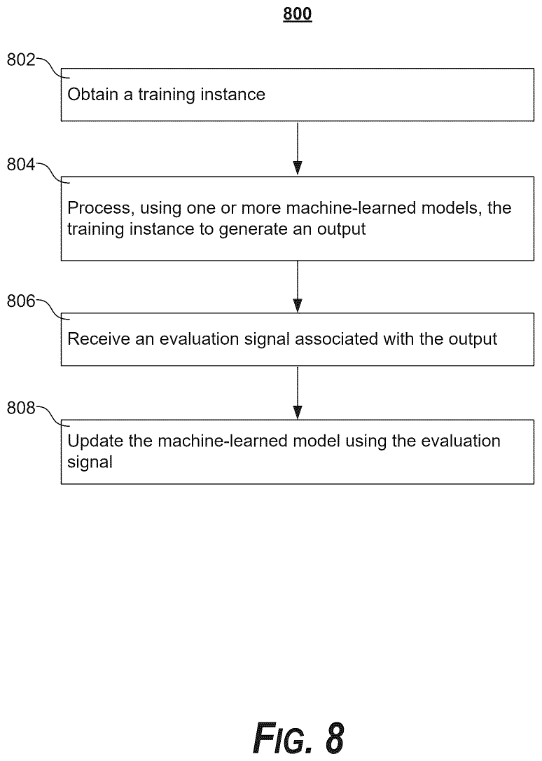

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

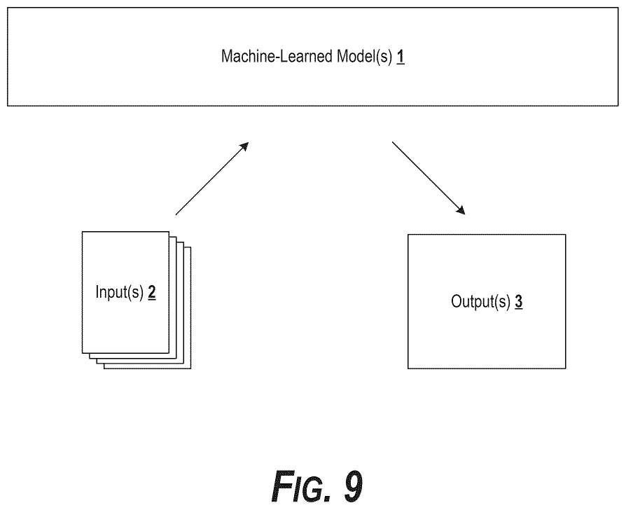

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM. Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of _.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

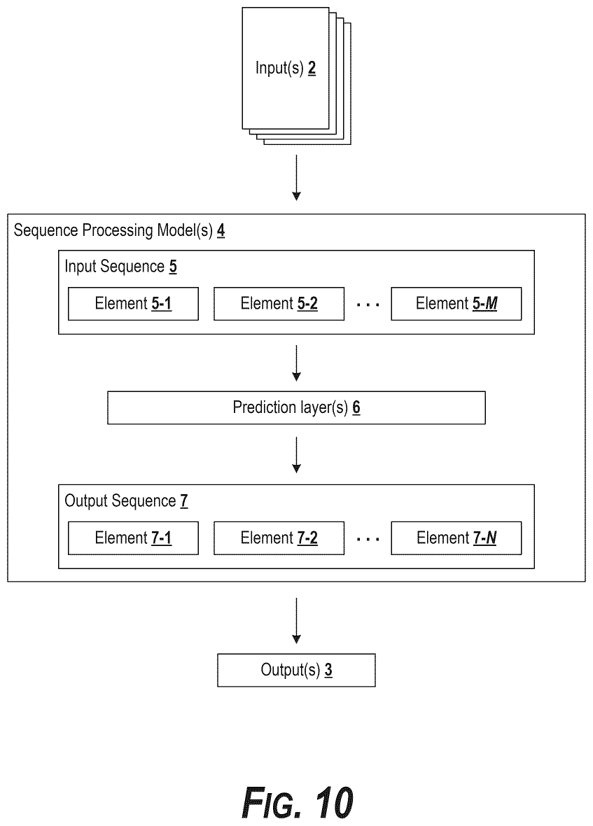

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

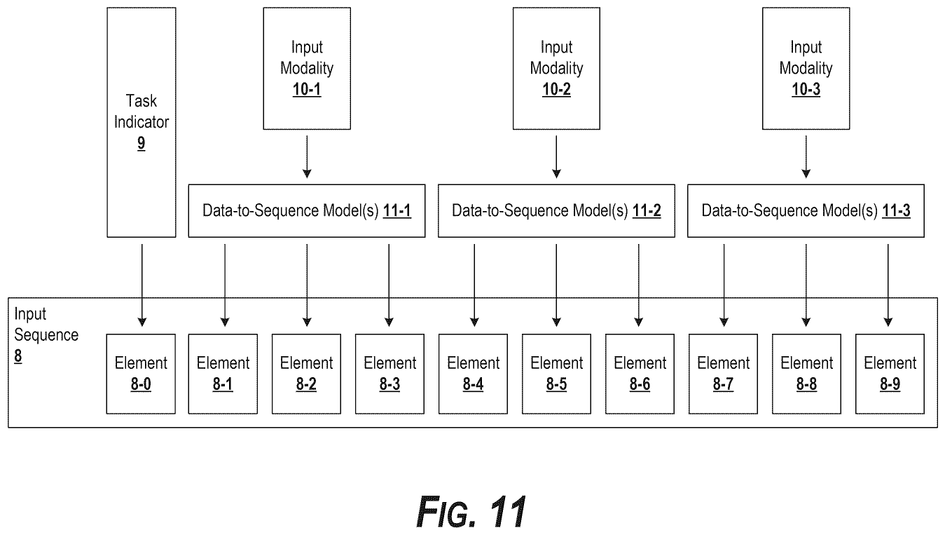

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

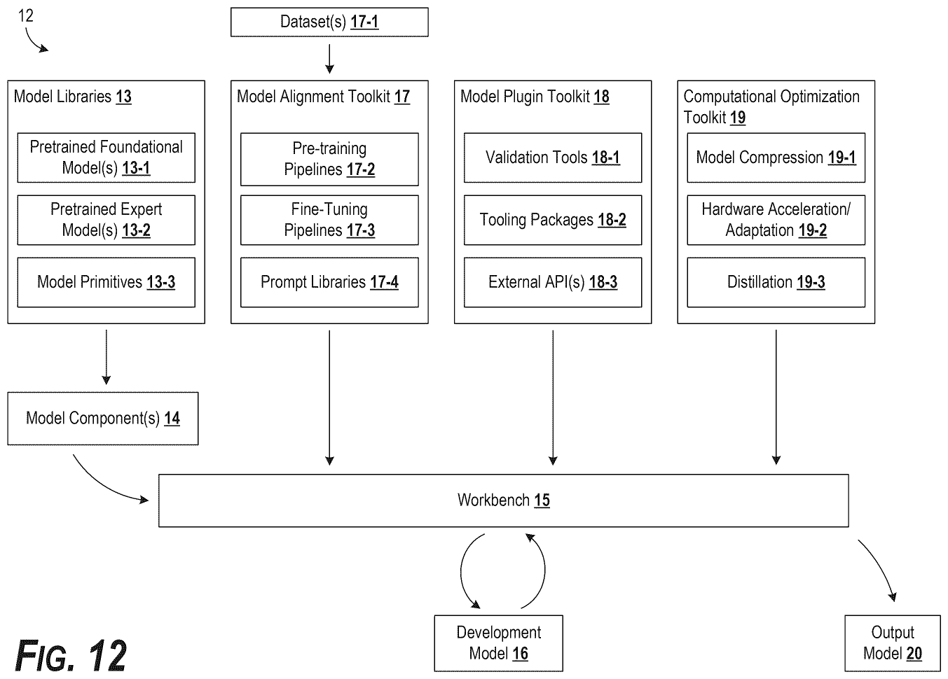

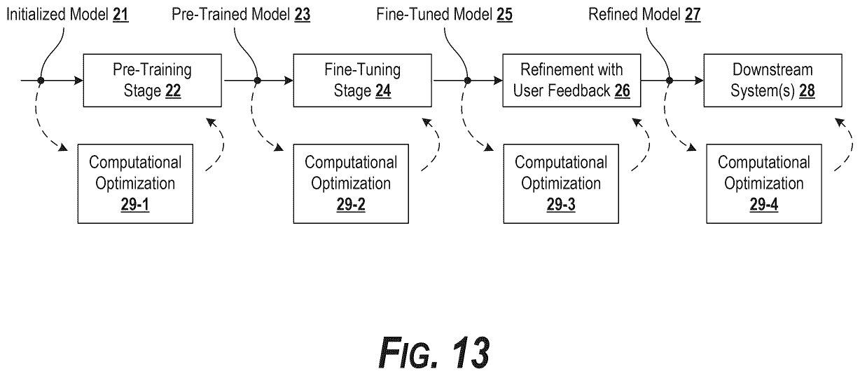

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

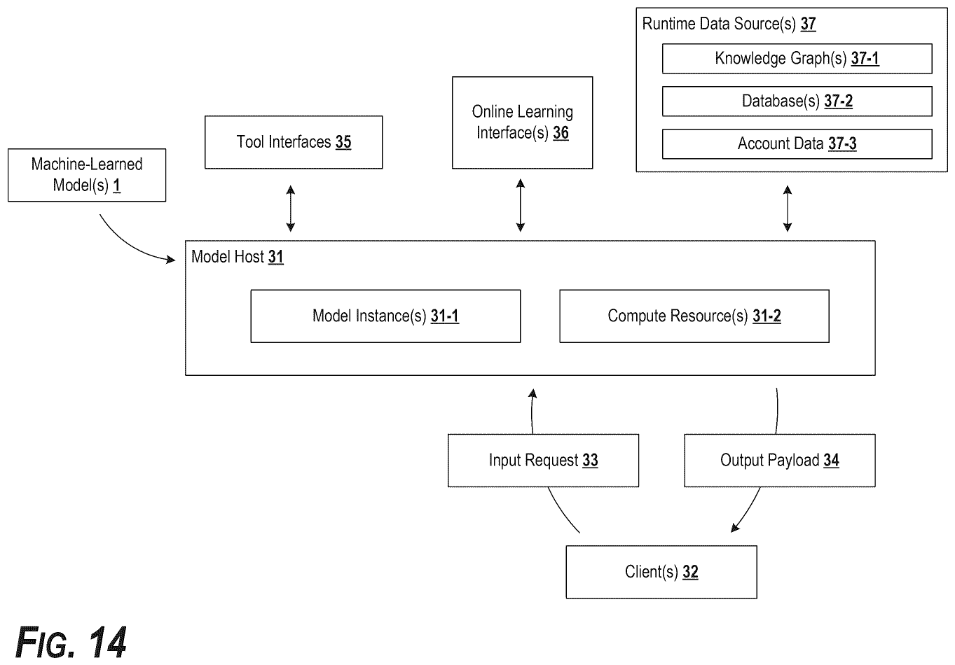

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

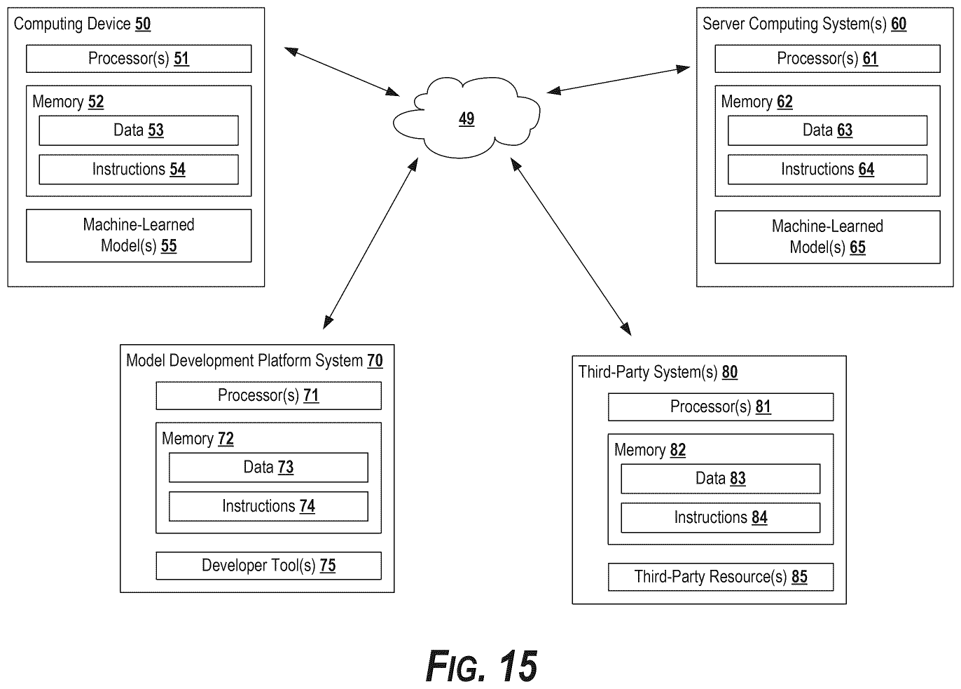

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

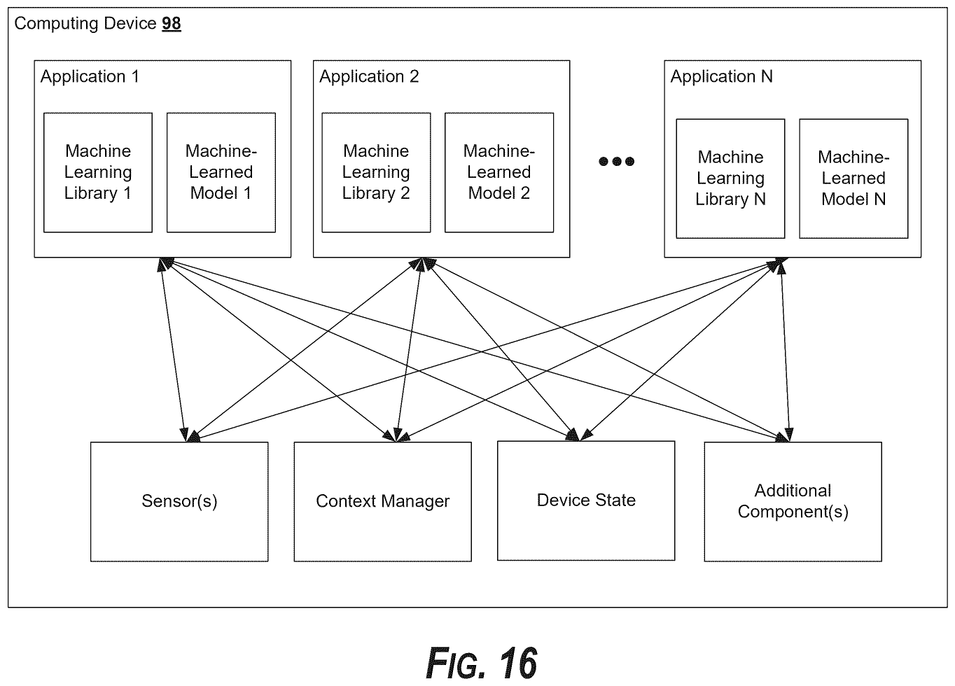

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

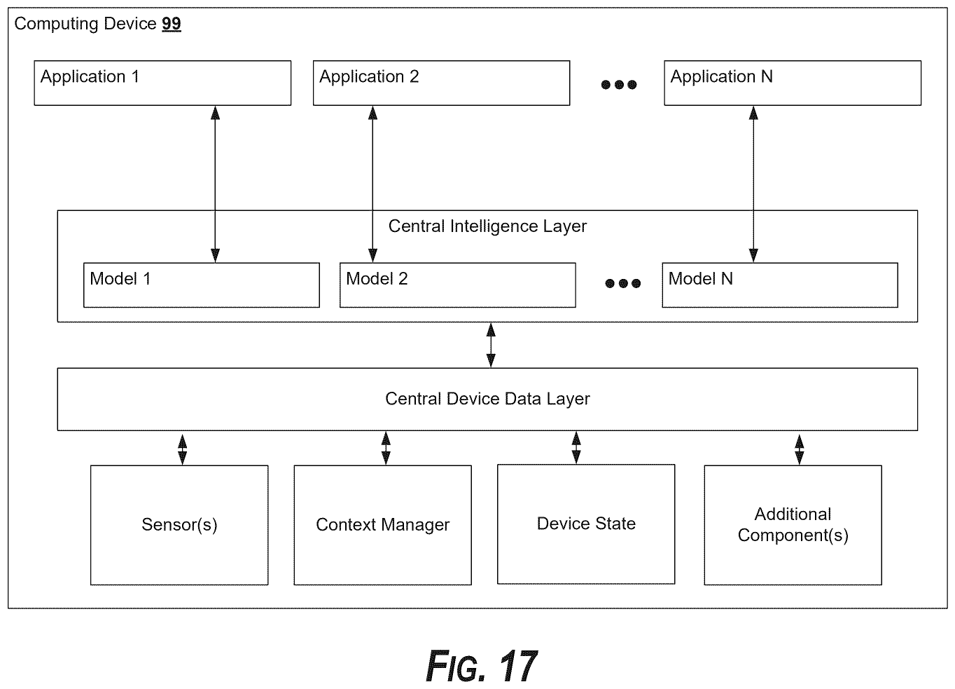

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method for generating a preference optimization loss function, the method comprising:
selecting a reward function, a regularizer, and a pairwise loss function;
optimizing a single-sequence generation objective which maximizes the selected reward function with regularization according to the selected regularizer, wherein said optimizing results in a solution expression for the selected reward function, wherein the solution expression is a function of a target probability associated with a target sequence processing model and a reference probability associated with a reference sequence processing model;
expressing a pairwise reward difference between the solution expression applied to a first sequence of tokens and the solution expression applied to a second sequence of tokens; and
generating the preference optimization loss function by applying the selected pairwise loss function to fit the pairwise reward difference to a human preference label, wherein the human pairwise preference label comprises a single label that describes a preference between the first sequence of tokens and the second sequence of tokens.

2. The method of claim 1, wherein optimizing the single-sequence generation objective comprises distributing respective probabilities for a first tied preference event and a second tied preference event to label values for a first non-tied preference event and a second non-tied preference event.

3. The method of claim 1, wherein the selected reward function comprises a per-sequence expected probability of a positive preference.

4. The method of claim 1, wherein the selected reward function comprises a logit score or a log of a preference probability.

5. The method of claim 4, wherein the selected pairwise loss function comprises a median loss function.

6. The method of claim 1, wherein the selected reward function comprises a logit score, wherein the selected pairwise loss function comprises a square loss function, and wherein the human pairwise preference label comprises a fractional preference label.

7. The method of claim 1, wherein the regularizer comprises a distance measure applied between a target distribution of the target sequence processing model and a reference distribution of the reference sequence processing model.

8. The method of claim 7, wherein the selected regularizer comprises a reverse KL divergence between the reference distribution and the target distribution.

9. The method of claim 1, wherein the selected reward function comprises a preference probability score and the selected pairwise loss function comprises a cross entropy loss.

10. The method of claim 1, wherein the selected reward function comprises a probability reward function, and wherein the selected regularizer comprises: a combination of a KL divergence and a reverse KL divergence; a Jensen-Shannon divergence; or an Lp regularizer, excluding L zero and L infinity.

11. The method of claim 1, wherein the selected pairwise loss function comprises: a cross entropy loss, a square loss, a median loss, or a hinge loss.

12. A computing system for preference optimization of sequence processing models, the computing system comprising one or more processors and one or more non-transitory computer-readable media that collectively store instructions that, when executed by the one or more processors, cause the computing system to perform operations, the operations comprising:
obtaining, by the computing system, a pairwise preference training example comprising a first sequence of tokens, a second sequence of tokens, and a pairwise preference label, wherein the pairwise preference label comprises one or more label values corresponding to a first non-tied preference event in which the first sequence of tokens is preferred over the second sequence of tokens or a second non-tied preference event in which the second sequence of tokens is preferred over the first sequence of tokens;
evaluating, by the computing system, a tied preference optimization loss function that comprises a pairwise preference probability expression that represents a predicted likelihood of the first non-tied preference event, wherein the pairwise preference probability expression results from distributing respective probabilities for a first tied preference event and a second tied preference event to the label values for the first non-tied preference event and the second non-tied preference event, wherein the first tied preference event comprises neither the first sequence of tokens nor the second sequence of tokens being preferred and the second tied preference event comprises both the first sequence of tokens and the second sequence of tokens being preferred; and
modifying, by the computing system, one or more values of one or more parameters of a target sequence processing model based on the tied preference optimization loss function.

13. The computing system of claim 12, wherein the pairwise preference probability expression represents the predicted likelihood of the first non-tied preference event based on first and second target probabilities respectively generated by the target sequence processing model for the first and second sequences of tokens and first and second reference probabilities respectively generated by a reference sequence processing model for the first and second sequences of tokens.

14. The computing system of claim 13, wherein the tied preference optimization loss function comprises a negative expectation of a first logarithm of a first expression, the first expression comprising one plus a hyperparameter times a second logarithm of a first ratio of the first target probability to the first reference probability minus the hyperparameter times a third logarithm of a second ratio of the second target probability to the second reference probability.

15. The computing system of claim 14, wherein evaluating the tied preference optimization loss function comprises clipping the first expression within the first logarithm to enforce constraints on a difference between first and second positive preference probabilities for the first and second sequences of tokens.

16. The computing system of claim 13, wherein the tied preference optimization loss function comprises an expectation of an absolute value of a first expression, the first expression comprising a hyperparameter times a first logarithm of a first ratio of the first target probability to the first reference probability minus the hyperparameter times a second logarithm of a second ratio of the second target probability to the second reference probability minus one.

17. The computing system of claim 13, wherein the tied preference optimization loss function comprises an expectation of an absolute value of a first expression, the first expression comprising the minimum between zero or a second expression, the second expression comprising a hyperparameter times a first logarithm of a first ratio of the first target probability to the first reference probability minus the hyperparameter times a second logarithm of a second ratio of the second target probability to the second reference probability minus one.

18. One or more non-transitory computer-readable media that collectively store a target sequence processing model that has been trained using a preference optimization loss function, the preference optimization loss function having been generated through performance of operations, the operations comprising:
obtaining a general objective comprising a reward function of a learned per-sequence expected probability of a positive preference and a distance measure applied between a target distribution of the target sequence processing model and a reference distribution of a reference sequence processing model;
solving the general objective for a solution expression of the target distribution of the target sequence processing model for a particular output sequence of tokens;
expressing, in terms of the solution expression, a difference between the reward function applied to a first sequence of tokens and the reward function applied to a second sequence of tokens; and
applying a pairwise loss to match the difference to a pairwise preference label associated with the first sequence of tokens and the second sequence of tokens.

19. The one or more non-transitory computer-readable media of claim 18, wherein the reward function comprises a preference probability score and the pairwise loss comprises a cross entropy loss.

20. The one or more non-transitory computer-readable media of claim 18, wherein the distance measure comprises a reverse KL divergence between the reference distribution and the target distribution.

21. The one or more non-transitory computer-readable media of claim 18, wherein the distance measure comprises a combination of a KL divergence and a reverse KL divergence.

22. The one or more non-transitory computer-readable media of claim 18, wherein the distance measure comprises a Jensen-Shannon divergence.

23. The one or more non-transitory computer-readable media of claim 18, wherein the distance measure comprises an Lp regularizer, excluding L zero and L infinity.

24. The one or more non-transitory computer-readable media of claim 18, wherein the pairwise loss comprises: a cross entropy loss, a square loss, or a hinge loss.

25. The one or more non-transitory computer-readable media of claim 18, wherein the preference optimization loss function evaluates first and second target probabilities respectively generated by the target sequence processing model for the first and second sequences of tokens and first and second reference probabilities respectively generated by the reference sequence processing model for the first and second sequences of tokens.

26. The one or more non-transitory computer-readable media of claim 25, wherein the preference optimization loss function comprises a negative expectation of a logarithm of a sigmoid of a first expression, the first expression comprising a hyperparameter times a first ratio of the second reference probability to the second target probability minus the hyperparameter times a second ratio of the first reference probability to the first target probability, and wherein the expectation is conditioned on the first sequence being preferred over the second sequence.

27. The one or more non-transitory computer-readable media of claim 25, wherein the preference optimization loss function comprises an expectation of a square of a first expression, the first expression comprising a hyperparameter times a first ratio of the second reference probability to the second target probability minus the hyperparameter times a second ratio of the first reference probability to the first target probability minus one.

28. The one or more non-transitory computer-readable media of claim 25, wherein the preference optimization loss function comprises an expectation of a square of a first expression, the first expression comprising a hyperparameter divided by two times a first logarithm of one plus a first ratio of the second reference probability to the second target probability minus the hyperparameter divided by two times a second logarithm of one plus a second ratio of the first reference probability to the first target probability minus one.

29. The one or more non-transitory computer-readable media of claim 25, wherein the preference optimization loss function comprises an expectation of a square of a first expression, the first expression comprising a hyperparameter times the first target probability minus the first reference probability minus the second target probability plus the second reference probability minus one-half or a fractional preference label.
